(19) United States
(12) Patent Application Publication
(10) Pub. No.: US 2001/0018158 A1
(43) Pub. Date: Aug. 30, 2001

(54) IMAGE FORMING METHOD

(76) Inventors: SATOSHI YOSHIDA, MISHIMA-SHI (JP); TSUTOMU KUKIMOTO, YOKOHAMA-SHI (JP); MANABU OHNO, NUMAZU-SHI (JP); YASUKAZU AYAKI, TOKYO (JP); SATOSHI HANDA, NAGAIZUMI-CHO (JP); AKIRA HASHIMOTO, NUMAZU-SHI (JP)

Correspondence Address: FITZPATRICK CELLA HARPER & SCINTO, 30 ROCKEFELLER PLAZA, NEW YORK, NY, 10112, US

(21) Appl. No.: 09/069,746

(22) Filed: Apr. 30, 1998

(30) Foreign Application Priority Data
Apr. 30, 1997 (JP) 9-111989
Apr. 30, 1997 (JP) 9-111990

(51) Int. Cl. G03G 13/095

(52) U.S. Cl. 430/125; 430/108.8; 430/110.2; 430/110.1; 430/111.4; 430/110.3; 430/108.4

(57) ABSTRACT

An image forming method comprises the steps of charging an electrostatic latent image bearing member, imagewise exposing the charged electrostatic latent image bearing member to form an electrostatic latent image thereon, developing the electrostatic latent image with a toner held on a toner holding member to form a toner image and transferring the toner image onto a transfer-receiving medium. The electrostatic latent image is developed by bringing a toner layer formed out of the toner held on the toner holding member into contact with the surface of the electrostatic latent image bearing member. The toner has toner particles containing at least a colorant, a wax and a binder resin. The wax: (a) in a DSC curve measured by a differential scanning calorimeter, shows an endothermic peak in a region from 50° C. to 130° C. when temperature is raised, and (b) in a spectrum measured by a ¹³C-NMR (nuclear magnetic resonance) measuring apparatus, satisfies the following conditions:

1.0≦[(S1/S)×100]≦10.0

1.5≦[(S2/S)×100]≦15.0

S1<S2

wherein S represents a total area of peaks detected in range from 0 to 50 ppm, S1 represents a total area of peaks detected in a range from 36 to 42 ppm, and S2 represents a total area of peaks detected in a range from 10 to 17 ppm.

### BACKGROUND OF THE INVENTION

1. Field of the Invention

This invention relates to an image forming method that utilizes electrophotography, electrostatic recording or magnetic recording. More particularly, it relates to an image forming method used in image forming apparatus such as copying machines, printers and facsimile machines in which toner images are formed on photosensitive members and thereafter the toner images are transferred to transfer mediums to form images.

2. Related Background Art

A number of methods are conventionally known as electrophotography. In general, copies are obtained by forming an electrostatic latent image on a photosensitive member by utilizing a photoconductive material and by various means, subsequently developing the electrostatic latent image by the use of a toner to form a toner image as a visible image, transferring the toner image to a transfer medium such as paper as occasion calls, and then fixing the toner image to the transfer medium by heating and/or pressing to form fixed images. Here, any toner not transferred to the transfer medium and remaining on the photosensitive member is removed by cleaning in various manners.

As methods by which the electrostatic latent image is formed into a visible image, developing methods such as cascade development, magnetic brush development and pressure development are known in the art. A magnetic one-component development system is also known in which, using a magnetic toner and using a rotary sleeve provided with a magnetic pole at its core, the magnetic toner is caused to fly from the sleeve to the photosensitive member under application of an electric field.

As printers, LED printers or LBP printers are prevailing in the recent market. As a trend of techniques, there is a tendency toward higher resolution. Those which hitherto have a resolution of 240 dpi or 300 dpi are being replaced by those having a resolution of 400 dpi, 600 dpi or 1,200 dpi. Accordingly, with such a trend, the developing systems are now required to achieve a high minuteness. Copying machines are progressing to have high functions, and hence they trend toward digital systems. In the digital systems, chiefly employed is a method in which electrostatic latent images are formed by using a laser. Hence, the copying machines also have come to have a high resolution and hence, like the printers, it has been sought to provide a developing system with high resolution and high minuteness.

Accordingly, toners are also being made to have smaller particle diameters, and toners having small particle diameters with specific particle size distributions are proposed in Japanese Patent Application Laid-Open Nos. 1-112253, 1-191156, 2-214156, 2-284158, 3-181952 and 4-162048.

In recent years, what is called contact one-component development systems are proposed in which a semiconductive developing roller or a developing roller which has a dielectric layer on its surface is pressed against the surface layer of a photosensitive member to carry out development.

In the one-component development systems, when a photosensitive member and a toner carrying member has a distance between them, the line of electric force may localize at the edges of electrostatic latent images formed on the photosensitive member, causing such an edge effect that the latent images are developed in a state of toner being concentrated toward the edges of images because the toner is placed along the line of electric force, and tending to result in a lowering of image quality.

The photosensitive member and the toner carrying member may be made very close in order to prevent such edge effect. It, however, is difficult to mechanically preset the gap between the photosensitive member and the toner carrying member, i.e., to set the gap smaller than the thickness of toner layer on the toner carrying member.

Accordingly, it is attempted to prevent the edge effect by the use of the contact one-component development system in which the toner carrying member is pressed against the photosensitive member to carry out development. If, however, the toner carrying member is driven at the same surface movement speed as that of the photosensitive member, no satisfactory images can be obtained when the latent images on the photosensitive member are rendered visible. Accordingly, in the contact one-component development system, the surface movement speed of the toner carrying member is allowed to differ from that of the photosensitive member so that a part of the toner on the toner carrying member may partly participate in development to render the latent images on the photosensitive member visible and another part of the toner is stripped off, so that developed images very faithful to the latent images and free of the edge effect can be obtained.

In such a contact one-component development system, it is essential for the system to be so constituted that the photosensitive member surface is rubbed with the toner and toner carrying member. This tend to cause deterioration of toner, deterioration and contamination of the toner carrying member surface, deterioration or wear and contamination of the photosensitive member surface, as a result of their long-term service. Thus, the deterioration of running performance is left as a problem, and it has been sought how to improve such a performance. Accordingly, for such reasons, the contact one-component development system has such basic problems that the apparatus must be improved in running performance and also it is difficult to achieve a higher speed that imposes a higher load to the apparatus.

Japan Hardcopy '89 Papers pp.25-28 discloses studies on a contact type non-magnetic one-component development system. It, however, does not refer to running performance.

FUJITSU Sci. Tech. J., 28, 4, pp.473-480 (December 1992) reports an outline of a printer making use of a contact one-component development system. Its running performance, however, is unsatisfactory and there is room for a further improvement.

Japanese Patent Application Laid-Open Nos. 5-188765 and 5-188752 disclosed a technique relating to a contact one-component development system, but does not disclose any technique relating to its running performance.

Meanwhile, toner images formed on the photosensitive member in the step of development are transferred to a transfer medium in the step of transfer. The transfer residual toner left on the photosensitive member is removed in the step of cleaning, and is stored in a waste toner container. In this cleaning step, cleaning methods such as blade cleaning, fur brush cleaning, roller cleaning and so forth are conventionally used. All of these cleaning methods are those by which a cleaning member is brought into contact with the photosensitive member surface to mechanically scrape off or block up the transfer residual toner so that it is collected in a waste toner container. Hence, because of the cleaning member pressed against the photosensitive member, all of these cleaning methods have caused problems. For example, strong press of the cleaning member wears the photosensitive member to shorten its lifetime. From the viewpoint of apparatus, the whole apparatus must be made larger in order to provide such a cleaning means. This has been a bottleneck in attempts to make apparatus compact.

In addition, from the viewpoint of ecology, a system that may produce no waste toner is long-awaited in the sense of effective utilization of toner, and, from the viewpoint of energy saving, a system having excellent fixing performance and anti-offset properties.

Disclosure of a technique called “cleaning-at-development” (cleaning simultaneously performed at the time of development) or “cleanerless” is, as seen in Japanese Patent Application Laid-Open No. 5-2287, focused on positive memory or negative memory appearing on images because of the influence of the transfer residual toner. However, in these days electrophotography is utilized more and more, it has become necessary to transfer toner images to various transfer mediums. In this sense, the above disclosure has not been satisfactory for various transfer mediums.

The prior art disclosing the cleanerless system is seen in Japanese Patent Application Laid-Open Nos. 59-133573, 62-203182, 63-133179, 64-20587, 2-302772, 5-2289, 5-53482 and 5-61383. All of these prior arts, however, neither mention any desirable image forming methods nor refer to how the toner should be constituted.

In the cleaning-at-development system basically having no cleaning assembly, it is essential for the system to be so made up that the photosensitive member surface is rubbed with the toner and toner carrying member, tending to cause deterioration of toner, deterioration of the toner carrying member surface and deterioration or wear of the photosensitive member surface as a result of their long-term service. Accordingly, since the prior art has made no satisfactory solution, it has been sought to achieve both the fixing performance and the running performance. At the same time, in these days images are desired to be formed at a higher speed, the prior art has made no satisfactory solution when the cleaning-at-development is carried out in apparatus having a higher process speed, with regard to how to control the charging of transfer residual toner prior to its collection in order to efficiently collect the transfer residual toner at development and how to keep development stability when the collected toner is reused.

Japanese Patent Application Laid-Open No. 3-259161 discloses a non-magnetic one-component developer whose shape factor, specific surface area and particle diameter are specified. The developer specified in this prior art has an insufficient running performance.

Japanese Patent Application Laid-Open No. 61-279864 discloses a toner whose shape factors SF-1 and SF-2 are specified. This prior art, however, does not mention at all the transfer. As a result of studies to follow up its Examples, the transfer efficiency was found to be so low as to require further improvement.

Japanese Patent Application Laid-Open No. 63-235953 discloses a magnetic toner whose particles have been made spherical by mechanical impact force. In this prior art, however, the transfer efficiency is still so low as to require further improvement.

In recent years, from the viewpoint of environmental protection, it is becoming dominant in the primary charging step and transfer step which have utilized corona discharging conventionally used, to employ a contact charging process in which a charging member is brought into contact with the photosensitive member surface to carry out charging and a contact transfer process in which a transfer member is brought into contact with the photosensitive member surface through a transfer medium to carry out transfer.

Such contact charging process and contact transfer process are disclosed in, e.g., Japanese Patent Application Laid-Open Nos. 63-149669 and 2-123385. In these processes, a conductive flexible charging roller is brought into contact with a photosensitive member and the photosensitive member is uniformly charged while applying a voltage to the conductive roller, followed by exposure and development to form a toner image. Thereafter, another conductive roller to which a voltage has been applied is pressed against the photosensitive member, during which a transfer medium is passed between them, and the toner image held on the photosensitive member is transferred to the transfer medium, followed by the step of fixing to obtain a fixed copy image.

Since, however, in such a contact transfer process, the transfer member is brought into contact with the photosensitive member through the transfer medium at the time of transfer, the toner image undergoes pressure when the toner image formed on the photosensitive member is transferred to the transfer medium, tending to cause a problem of partial faulty transfer, i.e., what is called “blank areas caused by poor transfer”.

Moreover, as the toner is made to have a smaller particle diameter, the attraction force (e.g., mirror force or van der Waals attraction) of toner particles on the photosensitive member may increase to tend to result in an increase in the transfer residual toner.

Accordingly, the toner and photosensitive member used in such an image forming method have been required to have excellent release properties.

It is known to incorporate a wax in toners as an anti-offsetting agent, as disclosed in, e.g., Japanese Patent Publication Nos. 52-3304 and 52-3305 and Japanese Patent Application Laid-Open No. 57-52574.

Japanese Patent Application Laid-Open Nos. 3-50559, 2-79860, 1-109359, 62-14166, 61-273554, 61-94062, 61-138259, 60-252361, 60-252360 and 60-217366 also disclose incorporation of waxes in toners.

Waxes are used for the purpose of improving anti-offset properties at the time of low-temperature fixing or high-temperature fixing of toners or improving fixing performance at the time of low-temperature fixing, but on the other hand tend to cause a lowering of blocking resistance of toners or a lowering of developing performance because of migration of wax toward toner particle surfaces. Hence, there has been such a problem that charging members are contaminated with the transfer residual toner in the cleaning-at-development and there have been limitations of the quantity of waxes to be added.

Toners produced by suspension polymerization are also proposed from long ago (e.g., Japanese Patent Publication No. 36-10231). In this suspension polymerization, polymerizable monomers and a colorant (further optionally a polymerization initiator, a cross-linking agent, a charge control agent and other additives) are uniformly dissolved or dispersed to prepare a monomer composition, and thereafter this monomer composition is dispersed in a continuous phase (e.g., an aqueous phase) containing a dispersion stabilizer by means of a suitable stirrer to allow polymerization to take place, obtaining toner particles having the desired particle diameters.

In this suspension polymerization, droplets of the monomer composition are formed in a dispersion medium having a great polarity such as water, and hence the component having polar groups which is contained in the monomer composition tends to be present at surface-layer portions corresponding to the interfaces with the aqueous phase and the component having no polarity is not present at the surface-layer portions. Thus, sherical toner parricles having what is called a core-shell structure or island-in-sea structure can be produced.

The toners obtained by polymerization, because of encapsulation of a release agent wax in toner particles, have become able to simultaneously achieve low-temperature fixing performance, blocking resistance and high-temperature anti-offset properties, which are performances conflicting with one another.

Use of such toners has an advantage that the colorant may hardly be laid bare to toner particle surfaces and a uniform triboelectric chargeability can be attained. It also becomes possible to omit the step of classification, and hence the production cost can be greatly effectively reduced, e.g., energy can be saved, time can be shortened and process yield can be improved.

However, toners obtained by such a process have substantially truly spherical particles, and hence toner particles may escape when in the above electrophotographic process the cleaning, in particular, blade cleaning is carried out, causing faulty cleaning and resulting in great damage of the quality of copied images in some cases.

Especially in the non-magnetic one-component development, the toner present on the photosensitive member as a toner image after development is so high in its charge quantity that the toner particles may have a greater force of attraction (mirror force) to the photosensitive member, resulting in an increase in the transfer residual toner. The transfer residual toner also is so higher in its charge quantity that the toner particles may also have a greater force of attraction to the photosensitive member, tending to cause faulty cleaning.

Meanwhile, also in the cleaning-at-development system, in which the step of cleaning to remove the transfer residual toner from the photosensitive member surface is carried out simultaneously at development in the developing step, external additives tend to become buried in the toner particle surfaces during long-term service to cause a lowering of chargeability of the toner, consequently often causing a deterioration of image quality. In particular, this phenomenon is more remarkable with an increase in process speed of developing rollers.

### SUMMARY OF THE INVENTION

An object of the present invention is to provide a technique for more preventing toner from deteriorating in an image forming method that employs a contact one-component development system in which an electrostatic latent image is formed on a photosensitive member and the electrostatic latent image is developed by bringing a toner layer formed on a toner carrying member into contact with the photosensitive member surface.

Another object of the present invention is to provide a technique for more preventing deterioration of the toner carrying member surface and photosensitive member (electrostatic latent image bearing member) surface.

Still another object of the present invention is to provide an image forming method that may cause no faulty cleaning even in the blade cleaning.

A further object of the present invention is to provide an image forming method that can make apparatus have a higher process speed.

A still further object of the present invention is to provide an image forming method that can improve fixing performance and anti-offset properties and can simultaneously achieve a running performance high enough to stably provide high-quality images over a long period of time.

A still further object of the present invention is to provide an image forming method that requires substantially no cleaning assembly.

A still further object of the present invention is to provide an image forming method that enables a system to be so designed as to have a very good transfer performance for various transfer mediums as exemplified by plain paper, cardboard and overhead projector transparent films, i.e., to have a broad transfer process latitude, in the image forming method employing the cleaning-at-development system.

A still further object of the present invention is to provide an image forming method that can achieve a superior transfer performance, may cause less transfer residual toner, and may cause no blank areas caused by poor transfer or may less cause such a phenomenon even in the contact transfer system.

A still further object of the present invention is to provide an image forming method that can form stable images over a long period of time without causing any faulty charging even in the contact charging process employing a contact charging member.

To achieve the above objects, the present invention provides an image forming method comprising the steps of;

electrostatically charging an electrostatic latent image bearing member;

subjecting the electrostatic latent image bearing member thus charged, to exposure to form thereon an electrostatic latent image;

developing the electrostatic latent image by the use of a toner carried on the surface of a toner carrying member, to form a toner image; and

transferring the toner image to a transfer medium via, or not via, an intermediate transfer member;

wherein, in the developing step, a toner layer formed by the toner carried on the surface of the toner carrying member is brought into contact with the surface of the electrostatic latent image bearing member,

the toner having toner particles containing at least a binder resin, a colorant and a wax, and the wax:

(a) in a DSC curve measured with a differential scanning calorimeter, showing a maximum endothermic peak in the region of from 50 to 130° C. at the time of temperature rise; and

(b) in a spectrum measured with a ¹³C-NMR (nuclear magnetic resonance) measuring device, satisfying the following conditions:

1.0≦[(S1/S)×100]≦10.0

1.5≦[(S2/S)×100]≦15.0

S1<S2

wherein S represents a total area of the peaks detected in the region of from 0 to 50 ppm, S1 represents a total area of the peaks detected in the region of from 36 to 42 ppm and S2 represents a total area of the peaks detected in the region of from 10 to 17 ppm.

### BRIEF DESCRIPTION OF THE DRAWINGS

FIG. 1 shows an example of ¹³C-NMR spectra of the wax according the present invention.

FIGS. 2A and 2B are diagrammatic views showing an example of cross sections of toner particles encapsulating a wax.

FIG. 3 is a schematic illustration of a device for measuring electrical resistance values of a developing roller.

FIG. 4 is a diagrammatic illustration of an image forming apparatus used as an example in the image forming method of the present invention, which makes use of a contact one-component developing assembly and also employs the cleaning-at-development system.

FIG. 5 is a diagrammatic illustration of an image forming apparatus used as another example in the image forming method of the present invention, which makes use of a contact one-component developing assembly and also employs a cleaning-before-development system.

FIG. 6 is a diagrammatic illustration of an image forming apparatus used as still another example in the image forming method of the present invention, which makes use of a contact one-component development system.

FIG. 7 is an enlarged view of the developing assembly of the image forming apparatus shown in FIG. 6.

FIG. 8 is a diagrammatic illustration of an image forming apparatus making use of an intermediate transfer member.

FIG. 9 illustrates a line-image original used to evaluate black spots around line images.

FIG. 10 illustrates an isolated-dot pattern used to evaluate dot reproducibility.

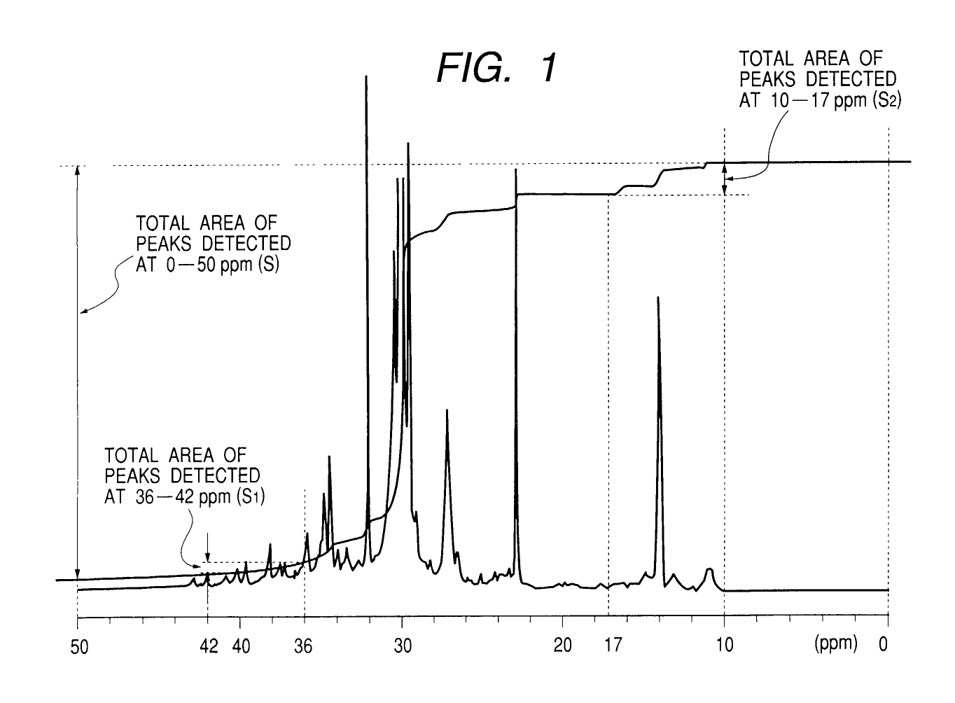

### DESCRIPTION OF THE PREFERRED EMBODIMENTS

According to the present invention, a toner making use of a wax having specific physical properties as a toner constituent is used in the image forming method having a one-component development process, whereby the toner can be prevented from contaminating, and melt-adhering to, the electrostatic latent image bearing member, charging member and toner carrying member, good fixing performance and good anti-offset properties can be simultaneously achieved, and images with a higher image quality can be stably formed.

In conventional image forming methods having a one-component development process, the deterioration of toner, deterioration of the toner carrying member surface and deterioration of the photosensitive member surface as a result of long-term service have been left as unsolved problems, which have made it difficult to make apparatus have a higher process speed.

However, the problem relating to the deterioration of toner and apparatus can be solved by incorporating in the toner the wax according to the present invention. Simultaneously, low-temperature fixing performance and high-temperature anti-offset properties can be imparted to the toner by incorporating in the toner the wax according to the present invention.

The wax according to the present invention is a wax having;

(a) in a DSC (differential scanning calorimetry) curve measured with a differential scanning calorimeter, a maximum endothermic peak in the region of from 50 to 130° C. at the time of temperature rise; and

(b) in a spectrum measured with a ¹³C-NMR (nuclear magnetic resonance) spectrometer, a total area (S) of the peaks detected in the region of from 0 to 50 ppm, a total area (S1) of the peaks detected in the region of from 36 to 42 ppm and a total area (S2) of the peaks detected in the region of from 10 to 17 ppm which satisfy the following relationship:

(1) 1.0≦[(S1/S)×100]≦10.0

(2) 1.5≦[(S2/S)×100]≦15.0

(3) S1<S2.

The wax that fulfills the above conditions may include long-chain branched waxes. Waxes having a long-chain branched structure, usable in the present invention, may include, e.g., waxes comprising hydrocarbon compounds having a long-chain branched structure represented by the following general formula:

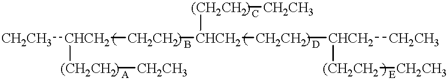

wherein A, C and E each represent an integer of 1 or more and B and D each represent an integer.

The above waxes can be produced by copolymerizing an α-monoolefinic hydrocarbon represented by:

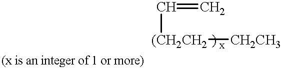

with ethylene. The α-monoolefinic hydrocarbon may preferably be a mixture of those having different values for x, and the value of x may preferably be 5 to 30 in order to more improve the low-temperature fixing performance and high-temperature anti-offset properties of the toner.

The wax according to the present invention may preferably be a low-softening substance, and as one feature, has a maximum endothermic peak in the region of from 50 to 130° C. at the time of temperature rise in a DSC curve measured with a differential scanning calorimeter. The wax having a maximum endothermic peak in the above temperature region greatly contributes to low-temperature fixing performance and simultaneously effectively exhibits release properties. If it has a maximum endothermic peak at below 50° C., its self-cohesive force is so weak that high-temperature anti-offset properties may be poor and also gloss may be too high. If, on the other hand, it has a maximum endothermic peak at above 130° C., the toner may have a high fixing temperature and also it may be difficult for fixed images to have appropriately smooth surfaces. Moreover, when granulation and polymerization are carried out in an aqueous medium to produce the toner directly by polymerization, a problem may undesirably occur such that the wax precipitates during granulation, if the maximum endothermic peak is at a high temperature.

The maximum endothermic peak temperature of the wax according to the present invention may be measured with a differential scanning calorimeter of a highly precise, inner-heat input compensation type as exemplified by DSC-7, manufactured by Perkin-Elmer Corporation.

The measurement is made according to ASTM D3418-82. In the present invention, the temperature of a sample is once raised to remove a previous history and thereafter rapidly dropped. The temperature is again raised at a temperature rate of 10° C./min within a temperature range of from 0 to 200° C., and the DSC curve thus measured is used.

Glass transition temperature Tg of the toner is also measured in the same way.

The wax used in the present invention has, in a spectrum measured with a ¹³C-NMR (nuclear magnetic resonance) spectrometer, the total area (S) of the peaks detected in the region of from 0 to 50 ppm, the total area (S1) of the peaks detected in the region of from 36 to 42 ppm and the total area (S2) of the peaks detected in the region of from 10 to 17 ppm which satisfy the relationship of the expressions (1), (2) and (3) shown above. The S1 originates from tertiary carbon atoms and quaternary carbon atoms which are present in the molecules of the wax. This means that the wax is not comprised of a straight-chain polymethylene but has a branched structure. The S2 originates from primary carbon atoms of methyl groups present at the terminals of backbone chains and branched chains of the wax.

The wax used in the present invention has a ratio [(S1/S)×100] of from 1.0 to 10.0 and a ratio [(S2/S)×100] of from 1.5 to 15.0. It may preferably have a ratio [(S1/S)×100] of from 1.5 to 8.0 and a ratio [(S2/S)×100] of from 2.0 to 13.0, and more preferably a ratio [(S1/S)×100] of from 2.0 to 6.0 and a ratio [(S2/S)×100] of from 3.0 to 10.0;

When the value of [(S1/S)×100], which corresponds to the percentage of presence of branched carbons that constructs the branched structure, is from 1.0 to 10, the migration of wax to toner particle surfaces can be appropriately controlled, so that the long-term storage stability of the toner can be improved, and simultaneously the photosensitive member, toner carrying member and toner can be prevented from their deterioration due to the stress caused by contact of the toner carrying member with the photosensitive member in the developing step and the photosensitive member and toner carrying member can be improved in running performance because of prevention of their contamination by toner. That is, it is presumed that the wax appropriately influences the toner particle surfaces to relax the stress at the contact part at the time of development.

When the value of [(S2/S)×100], which corresponds to the percentage of presence of long-chain branched carbons, is from 1.5 to 15, the balance between the viscosity and elasticity of the toner in an environment of high temperature can be optimized, and hence the high-temperature anti-offset properties can be improved and simultaneously the low-temperature fixing performance can be improved while maintaining an appropriate gloss.

If the value of [(S1/S)×100] is less than 1.0 and the value of [(S2/S)×100] is less than 1.5, it means that the long-chain branches are present in a small number in the molecules constituting the wax, so that, when the wax is in a molten state, the molecules constituting the wax are less entangled with one another to cause a decrease in melt viscosity, making it difficult to achieve the improvement of high-temperature anti-offset properties. Also, because of a small number of long-chain branches, the molecules constituting the wax may be so soft as to increase the possibility of contamination of members coming into contact with the wax.

If, on the other hand, the value of [(S1/S)×100] is more than 10.0 and the value of [(S2/S)×100] is more than 15.0, it means that the long-chain branches are present in a large number in the molecules constituting the wax, which causes an increase in melt viscosity, making it difficult to achieve the improvement of low-temperature fixing performance. Also, because of a large number of long-chain branches, the molecules constituting the wax may be so hard that the wax may scratch the surfaces of the photosensitive member and toner carrying member or accelerates their wear, resulting in a lowering of running performance. Also, if the molecules constituting the wax are hard, it may be difficult for the wax to be uniformly dispersed, and hence the toner may be non-uniformly charged to tend to cause fog.

The effect of improvement in electrophotographic performances as stated above can be more enhanced by using a wax whose branched structure has so developed that the long-chain branched chains have short-chain branched chains further branched therefrom. Hitherto, the development of the branched structure of waxes has caused various difficulties ascribable to dispersibility or the like. However, controlling the branch density and branched-chain condition as described above can avoid such difficulties. In addition, it is one of preferred embodiments of the present invention to mix a straight-chain wax so long as the values are within the above ranges.

In the present invention, the ¹³C-NMR spectra of the wax are measured under the following conditions.

Conditions for Measurement of ¹³C-NMR—

Measuring device: FT NMR device JNM-EX400 (manufactured by Nippon Denshi K. K.)

¹³C measurement frequency: 100, 40 MHz

Pulse condition: 5.0 μs (45° C.), by DEPT process

Data points: 32,768

Retardation time: 25 sec.

Measurement frequency: 10,500.00 MHz

Integration times: 1,000 times

Measurement temperature: 110° C.

A sample to be measured is prepared in the following way: 200 mg of a sample is put into a sample tube of 10 mm in diameter, and a benzene-d6/o-dichlorobenzene-d4 (1/4) mixture is added as a solvent, followed by dissolution in a 110° C. thermostatic chamber, preparing a measuring solution.

When the wax has the long-chain branched structure, the toner containing such a wax can be improved in low-temperature fixing performance and high-temperature anti-offset properties, and controlled in the properties of contaminating members such as the electrostatic latent image bearing member and the toner carrying member. Also, when the toner is melt-kneaded in its production, a shear force can be desirably applied to the whole composition prepared for forming the toner, and hence the toner constituent materials can be dispersed in an improved state to bring about an improvement in developing performance. This tendency is more effectively seen when a polymerization toner is produced, to which a shear force is hard to apply, and the polymerization toner thus obtained can have a good dot reproducibility.

The wax according to the present invention may include waxes obtained from low-molecular weight polyalkylenes obtained by radical polymerization of alkylenes at a high temperature under a high pressure or polymerization thereof in the presence of a Ziegler catalyst, and by-products from the polymerization; low-molecular-weight polyalkylenes obtained by thermal decomposition of high-molecular-weight polyalkylenes; and low-molecular-weight polyalkylenes obtained by oxidation of high-molecular-weight polyalkylenes.

From these waxes, waxes may be fractionated according to molecular weight by press sweating, solvent fractionation, vacuum distillation, ultracritical gas extraction or fractionation recrystallization (e.g., molten liquid crystallization and crystal filtration). Such waxes may also preferably be used in the present invention. After the fractionation, oxidation, block copolymerization or graft modification may be carried out.

The wax used in the present invention, having the long-chain branched structure, may preferably have a weight-average molecular weight (Mw) of from 600 to 50,000, more preferably from 800 to 40,000, and still more preferably from 1,000 to 30,000. The wax having the long-chain branched structure may also preferably have a number-average molecular weight of from 400 to 4,000, and more preferably from 450 to 3,500. The wax having the long-chain branched structure may also preferably have a value of Mw/Mn of from 3.5 to 30, and more preferably from 4 to 25.

In a case where the toner of the present invention is a toner formed by melt-kneading and pulverization, the wax may preferably be incorporated in an amount of from 1 to 20 parts by weight, more preferably from 2 to 17 parts by weight, and still more preferably from 3 to 15 parts by weight, based on 100 parts by weight of the binder resin. The toner containing the wax in the above quantity is preferable because the toner can be improved in low-temperature fixing performance, blocking resistance and anti-offset properties and also because wax particles that may be liberated from toner particles can be in a smaller quantity.

In the case of the toner produced by polymerization, the wax may preferably be encapsulated in toner particles in an amount of from 5 to 20 parts by weight based on 100 parts by weight of the resin component of the toner particles.

An antioxidant may also be added to the wax so long as it does not affect the charging performance of the toner.

The wax having the long-chain branched structure may be used in combination with a relatively low-melting point wax or a relatively high-melting point wax.

In such combination, a maximum endothermic peak temperature (W1° C.) of the wax having the long-chain branched structure and a maximum endothermic peak temperature (W2° C.) of the wax used in combination may preferably satisfy the following relationship:

80(° C.)≦(W1+W2)/2≦110(° C.).

The wax used in combination with the wax having the long-chain branched structure may be used in a proportion of from 1/4 to 9/1, more preferably from 1/3 to 8/1, and still more preferably from 1/2 to 7/1, in weight ratio. When they satisfy the above proportion, the toner can be more improved in low-temperature fixing performance and high-temperature anti-offset properties without damaging the excellent properties inherent in the wax having the long-chain branched structure.

In the toner of the present invention, besides the foregoing waxes, at least one additional third wax may be incorporated so long as the effect of the present invention is not impaired, in order to make delicate adjustment of low-temperature fixing performance, blocking resistance or anti-offset properties. Such an additional wax may be contained in an amount not more than 20% by weight based on the total wax weight, and may preferably have a maximum endothermic peak temperature of from 60 to 140° C.

The combination of waxes preferably used in the present invention may include the following combination.

(1) Combination of a low-melting long-chain branched wax with a high-melting long-chain branched wax:

The low-melting long-chain branched wax may be one having a maximum endothermic peak temperature of from 60 to 80° C., a weight-average molecular weight of from 700 to 20,000 and an Mw/Mn of from 4 to 15.

The high-melting long-chain branched wax may be one having a maximum endothermic peak temperature of from 90 to 120° C., a weight-average molecular weight of from 1,500 to 40,000 and an Mw/Mn of from 5 to 20.

(2) Combination of a low-melting long-chain branched wax with a high-melting wax:

As the low-melting long-chain branched wax, those shown in the above (1) may be used.

The high-melting wax may be a polypropylene wax, an ethylene-propylene copolymer wax or a wax comprised of long-chain and less branched alkyl groups and may preferably be those which have substituents other than hydrogen atoms at its terminals or at some part in the molecules (the substituents include hydroxyl groups and/or carboxyl groups) and in which an alkyl component having a substituent is contained in an amount of at least 50% by weight in the high-melting wax. The high-melting wax may preferably be those having a maximum endothermic peak temperature of from 85 to 150° C., a weight-average molecular weight of from 800 to 15,000 and an Mw/Mn of from 1.5 to 3.

(3) Combination of a low-melting wax with a high-melting long-chain branched wax:

The low-melting wax is a wax having a long-chain alkyl group with less branches. It may have substituents other than hydrogen atoms at its terminals or at some part in the molecules. When it has substituents, the substituents include hydroxyl groups and/or carboxyl groups) and a wax having an alkyl component with a substituent may preferably be contained in an amount of at least 40% by weight in the low-melting wax. The low-melting wax may preferably be those having a maximum endothermic peak temperature of from 70 to 90° C., a weight-average molecular weight of from 400 to 700 and an Mw/Mn of from 1.5 to 2.5.

The low-melting wax may include hydrocarbon waxes having a long-chain alkyl group with less branches. It may specifically include low-molecular-weight alkylene polymer waxes obtained by polymerizing alkylenes using radical polymerization under high pressure or by polymerization in the presence of a Ziegler catalyst under low pressure; alkylene polymer waxes obtained by thermal decomposition of high-molecular-weight alkylene polymers; and synthetic hydrocarbon waxes obtained from, or by hydrogenation of, distillation residues of hydrocarbons of polymethylene obtained by the Arge process from synthetic gases comprised of carbon monoxide and hydrogen. Hydrocarbon waxes fractionated by utilizing press sweating, solvent fractionation or vacuum distillation or by a fractionation recrystallization system may more preferably be used. The hydrocarbons, serving as a matrix, may include polymethylene waxes synthesized by reacting carbon monoxide with hydrogen in the presence of a metal oxide type catalyst (usually catalysts of a two or more multiple system). They may also include waxes obtained by the Synthol method, the Hydrocol process (making use of a fluidized catalyst bed), or the Arge process (making use of a fixed catalyst bed) which can obtain waxy hydrocarbons in a large quantity.

The above long-chain alkyl group may be substituted at some part of terminals thereof with a hydroxyl group or a functional group (e.g., a carboxyl group, an ester group, an ethoxy group or a sulfonyl group) derived from a hydroxyl group. A long-chain alkyl alcohol can be obtained, e.g., in the following way: Ethylene is polymerized in the presence of a Ziegler catalyst. After the polymerization is completed, the polymer obtained is oxidized to form an alkoxide of the catalyst metal with polyethylene, followed by hydrolysis to obtain the long-chain alkyl alcohol.

The high-melting wax may include hydrocarbon waxes having a longer chain with less branches, and ethylene-propylene copolymers. Specifically, it may include, e.g., low-molecular-weight alkylene polymer waxes obtained by polymerizing alkylenes by radical polymerization under high pressure or by polymerization in the presence of a Ziegler catalyst under low pressure; alkylene polymer waxes obtained by thermal decomposition of high-molecular-weight alkylene polymers; and synthetic hydrocarbon waxes obtained from, or by hydrogenation of, distillation residues of hydrocarbons of polymethylene obtained by the Arge process from synthetic gases comprised of carbon monoxide and hydrogen.

The above long-chain alkyl group may be substituted at some part of terminals thereof with a hydroxyl group or a functional group (e.g., a carboxyl group, an ester group, an ethoxy group or a sulfonyl group) derived from a hydroxyl group, or may form a copolymer with styrene, acrylic or methacrylic acid (or ester) or maleic anhydride.

As an example of a developing assembly relating to the image forming method of the present invention, named is a developing assembly employing a system in which a one-component developer (toner) is applied on the surface of a toner carrying member having an elastic rubber layer on its surface, to form a toner layer and the toner layer formed is brought into contact with the surface of an electrostatic latent image bearing member (photosensitive member). Here, it does not matter whether the toner is magnetic or non-magnetic, but it is important that the toner and the photosensitive member surface come into contact with each other. The toner carrying member substantially comes into contact with the photosensitive member surface, which means that the toner carrying member comes into contact with the photosensitive member when the toner is removed from the toner carrying member. Here, in order to obtain images free of the edge effect with the assistance of an electric field acting between the photosensitive member and the toner carrying member facing the surface of the photosensitive member through the toner, the toner carrying member is required to have a potential on or near its surface and the electric field should be formed between the photosensitive member surface and the toner carrying member surface. Hence, the elastic rubber layer on the surface of the toner carrying member may be resistance-controlled in a medium-resistance region so as to keep the electric field while preventing electrical contact with the photosensitive member surface, or a thin-layer dielectric layer may be formed on the surface of the toner carrying member whose surface layer is conductive; either method may be used. The assembly may also be so constituted that the conductive surface of the toner carrying member is formed out of a conductive resin sleeve coated with an insulating substance or that an insulating toner carrying member is provided with a conductive layer on its inner side.

When the contact development system making use of a one-component developer is employed, the toner carrying member that carries the developer may be rotated in the same direction as the photosensitive member, or may be rotated in the opposite direction. When rotated in the same direction, the toner carrying member may preferably be rotated at a peripheral speed higher than that of the photosensitive member. If the toner carrying member is rotated at a peripheral speed lower than that of the photosensitive member, a problem may be left on image quality, e.g., a poor line sharpness. With an increase in the peripheral speed of the toner carrying member with respect to the photosensitive member, the quantity of the toner fed to the development zone increases, and hence, the toner is more frequently attached to and detached from the latent image, where the toner is repeatedly scraped off at the unnecessary part and imparted to the necessary part, so that an image faithful to the latent image can be formed.

In the present invention, it is preferable to provide a cleaning step for removing the transfer residual toner not transferred in the transfer step and remaining on the surface of the photosensitive member. A system of cleaning includes a cleaning-before-development system and the cleaning-at-development system.

In the cleaning-before-development system, a cleaning member is brought into contact with the photosensitive member surface at a position corresponding to the side downstream to the transfer zone and the side upstream to the charging zone to remove the transfer residual toner remaining on the photosensitive member. Since the cleaning member is provided on the side upstream to the charging zone, the transfer residual toner can be made to less affect the charging member.

As the cleaning member used in the cleaning-before-development system, a blade, a roller, a fur brush or a magnetic brush may be used. Two or more of these cleaning members may be used in combination.

Since, however, in the cleaning-before-development system the cleaning is carried out by pressing the cleaning member against the photosensitive member surface, the following problems tend to arise: a short lifetime of the photosensitive member due to wear, filming on the photosensitive member surface by the toner and contamination of the cleaning member. In the cleaning-before-development system, in particular, in a cleaning system making use of a cleaning blade, the toner may slip through the cleaning blade when a true-spherical toner is used, causing the problem of faulty cleaning. In the present invention, the use of the toner containing the wax having the aforementioned properties promises a much superior cleaning performance.

The cleaning-at-development system is a system in which the transfer residual toner is collected in the developing step without the use of a cleaning member. Its principle is to control the charge polarity and charge quantity of the toner on the photosensitive member in the respective steps in electrophotography and employ a reversal development system.

It will be described by giving an example. When a negatively chargeable photosensitive member and a negatively chargeable toner are used, a visualized image is transferred to a transfer medium in the transfer step by means of a transfer member having a positive polarity, where the charge polarity of the transfer residual toner varies from positive to negative in relation to, e.g., the types of transfer mediums (differences in thickness, resistance, dielectric constant and so forth) and the areas of images. However, the charging member having a negative polarity, used to charge the negatively chargeable photosensitive member, can uniformly adjust the charge polarity to the negative side even if the polarity of the transfer residual toner has been shifted to the positive side in the transfer step. Hence, when the reversal development is employed as the developing system, the negatively charged transfer residual toner remains at the toner light-portion potential areas to be developed. At the toner dark-portion potential areas not to be developed, the toner is attracted toward the toner carrying member in relation to the development electric field and does not remain on the photosensitive member having a negative potential.

Thus, the cleaning-at-development system can be said to be established by controlling the charge polarity of the transfer residual toner simultaneously with the charging of the photosensitive member. In this step, however, the charging member may be contaminated, thereby tending to cause faulty charging.

Especially in the contact charging, in which a charging member is brought into contact with a photosensitive member to charge the photosensitive member, the charging mechanism may utilize electric discharge following the Paschen's low, where the adhesion of toner to the charging member occurs which is caused by the facts that the charging member comes into contact with the photosensitive member and the energy of electric discharge deteriorates the toner.

The present inventors examined how the transfer residual toner affects the charging member in the image forming method making use of the cleaning-at-development system. As a result, it was revealed that the toner passing through the charging member on the photosensitive member is chemically influenced when its charge polarity is controlled, and the toner thus influenced adversely affects running performance and image quality characteristics.

In the cleaning-before-development system, the transfer residual toner is removed from the surface of the photosensitive member by means of the cleaning member such as a blade or a fur brush, where the charging of the photosensitive member is considered not to affect the toner or developer. Hence, it is unnecessary to take into account any chemical influence due to the charging of the toner present on the photosensitive member.

However, in the image forming method making use of the cleaning-at-development system, the toner affected by the charging member on the photosensitive member is collected in the developing assembly and reused, thus it is necessary to take such chemical influence into account.

The present inventors made extensive studies on various toners, and have discovered that, in the image forming method making use of the cleaning-at-development or cleanerless system, specific physical properties of waxes contained in toners are closely concerned with the running performance and image quality characteristics, and also that the use of the wax according to the present invention, having the properties as previously described, brings about an excellent cleaning performance.

The binder resin used in the present invention may include a styrene-acrylate or methacrylate copolymer, polyester resins, epoxy resins and a styrene-butadiene copolymer, which are commonly used. In the method in which the toner particles are directly obtained by polymerization, the monomers for constituting any of these are preferably used. Specifically, the following are preferably used: styrene; styrene type monomers such as o-, m- or p-methylstyrene, and m- or p-ethylstyrene; acrylic or methacrylic ester monomers such as methyl acrylate or methacrylate, ethyl acrylate or methacrylate, propyl acrylate or methacrylate, butyl acrylate or methacrylate, octyl acrylate or methacrylate, dodecyl acrylate or methacrylate, stearyl acrylate or methacrylate, behenyl acrylate or methacrylate, 2-ethylhexyl acrylate or methacrylate, dimethylaminoethyl acrylate or methacrylate, and diethylaminoethyl acrylate or methacrylate; and olefin monomers such as butadiene, isoprene, cyclohexene, acrylo- or methacrylonitrile, and acrylic amide. Any of these may be used alone, or usually used in an appropriate mixture of monomers so mixed that the theoretical glass transition temperature (Tg) as described in POLYMER HANDBOOK, 2nd Edition, pp.139-192 (John Wiley & Sons, Inc.) ranges from 40 to 75° C. If the theoretical glass transition temperature is lower than 40° C., problems may arise in respect of storage stability or running stability of the toner. If, on the other hand, it is higher than 75° C., the fixing point of the toner may rise.

Molecular weight of the binder resin is measured by GPC (gel permeation chromatography). As a specific method for measurement by GPC, the toner is beforehand extracted with a toluene solvent for 20 hours by means of a Soxhlet extractor, and thereafter the toluene is evaporated by means of a rotary evaporator, followed by adding an organic solvent capable of dissolving the low-softening substance but dissolving no binder resin (e.g., chloroform), to thoroughly carry out washing. Thereafter, the solution is dissolved in tetrahydrofuran (THF), and then filtered with a solvent-resistant membrane filter of 0.3 μm in pore diameter to obtain a sample. Molecular weight of the sample is measured using a detector 150C, manufactured by Waters Co. As the column constitution, A-801, A-802, A-803, A-804, A-805, A-806 and A-807, available from Showa Denko K. K., are connected, and molecular weight distribution can be measured using a calibration curve of a standard polystyrene resin. The resin component obtained may preferably have a number average molecular weight (Mn) of from 5,000 to 1,000,000, and a binder resin is preferred in which the ratio of the weight average molecular weight (Mw) to the number average molecular weight (Mn), Mw/Mn, is in a range from 2 to 100.

In the present invention, a toner having core/shell structure is preferred. The core/shell structure is a structure wherein cores formed of wax are covered with shells formed of a resin synthesized by polymerization of polymerizable monomers. The toner having core/shell structure encapsulates the wax in toner particles and hence can be prevented from its deterioration and its contamination of image forming apparatus, so that a good charging performance can be maintained and it becomes possible to form toner images with an excellent dot reproducibility over a long period of time. When heated, the wax can act in a good efficiency, and hence such a toner can satisfy both the low-temperature fixing performance and the anti-offset properties

In the present invention, the core/shell structure can be confirmed by observing cross sections of toner particles.

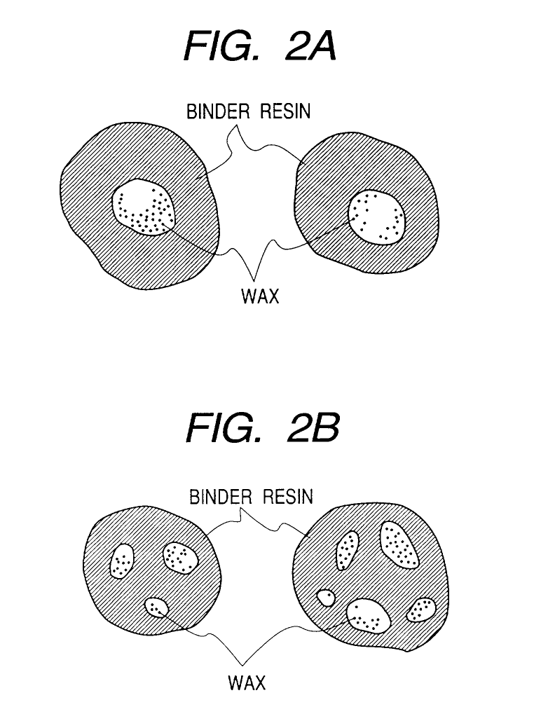

Cross sections of the toner particles can be observed by a method in which toner particles are well dispersed in a room-temperature curing resin, followed by curing in an environment of temperature 40° C. for 2 days, and the cured product obtained is dyed with triruthenium tetraoxide (optionally in combination with triosmium tetraoxide), thereafter samples are cut out in slices by means of a microtome having a diamond cutter to observe the cross-sectional forms of toner particles using a transmission electron microscope (TEM). In the present invention, it is preferable to use the triruthenium tetraoxide dyeing method in order to form a contrast between the materials by utilizing some difference in crystallinity between the low-softening substance used and the resin constituting the shell. Typical examples are shown in FIGS. 2A and 2B. Toner particles obtained in Examples given later are observed to confirm that the low-softening substance is encapsulated with the shell resin.

To produce the toner having such core/shell structure, suspension polymerization described later may preferably be used. When the toner particles are produced by suspension polymerization, it is particularly preferable to further add a polar resin in addition to the shell resin for encapsulating the low-softening substance. As the polar resin used in the present invention, copolymers of styrene with acrylic or methacrylic acid, maleic acid copolymers, saturated polyester resins, polycarbonates and epoxy resins are preferably used.

In the toner particles, the polar resin may preferably be contained in an amount of from 1 to 20% by weight, and more preferably from 2 to 16% by weight, based on the weight of the toner particles. If the polar resin is in a content less than 1% by weight, its addition cannot be well effective. If, on the other hand, it is in a content more than 20% by weight, it may often affect charge characteristics of the toner, undesirably tending to cause a lowering of the charging performance of toner especially in an environment of high temperature and high humidity.

In the present invention, the surfaces of the toner particles may be further provided with an outermost shell resin layer.

Such an outermost shell resin layer may preferably have a glass transition temperature so designed as to be higher than the glass transition temperature of the shell resin in order to more improve blocking resistance. The outermost shell resin layer may also preferably be cross-linked to such an extent that the fixing performance is not damaged. The outermost shell resin layer may preferably be incorporated with a polar resin or a charge control agent in order to improve charging performance.

There are no particular limitations on how to provide the outermost shell resin layer. For example, it may be provided by a method including the following.

1. A method in which, at the latter half or after the completion of polymerization reaction, a monomer composition prepared by dissolving or dispersing a polar resin, a charge control agent, a cross-linking agent and so forth is optionally added, and adsorbed on polymerization particles, followed by adding a polymerization initiator to carry out polymerization.

2. A method in which emulsion polymerization particles or soap-free polymerization particles produced from a monomer composition containing a polar resin, a charge control agent, a cross-linking agent and so forth are optionally added in the reaction system, and are allowed to cohere to the surfaces of polymerization particles, optionally followed by heating to fix them.

3. A method in which emulsion polymerization particles or soap-free polymerization particles produced from a monomer composition containing a polar resin, a charge control agent, a cross-linking agent and so forth are optionally allowed to mechanically fix to the surfaces of toner particles.

In order to faithfully develop minute latent-image dots to achieve a much higher image quality, the toner particles may have a weight-average particle diameter of from 3 μm to 9 μm, and preferably from 4 μm to 8 μm, and a coefficient of variation of 35% or less, and preferably 25% or less, in number distribution. If the toner particles have a weight-average particle diameter smaller than 3 μm, particles of transfer residual toner may remain in a large quantity on the photosensitive member or intermediate transfer member because of the lowering of transfer efficiency, and also such particles tend to cause uneven images due to faulty transfer. If the toner particles have a weight-average particle diameter larger than 9 μm, the toner tend to melt-adhere to the photosensitive member surface or intermediate transfer member. This tendency may be more remarkable if the toner particles have a coefficient of variation of more than 35% in number distribution.

The average particle diameter and particle size distribution of the toner can be measured with a Coulter counter Model TA-II or Coulter Multisizer (manufactured by Coulter Electronics, Inc.). An interface (manufactured by Nikkaki k. k.) that outputs number distribution and volume distribution and a personal computer PC9801 (manufactured by NEC.) are connected. As an electrolytic solution, an aqueous 1% NaCl solution is prepared using first-grade sodium chloride. For example, ISOTON R-II (available from Coulter Scientific Japan Co.) may be used. Measurement is carried out by adding from 0.1 to 5 ml of a surface active agent as a dispersant, preferably an alkylbenzene sulfonate, to from 100 to 150 ml of the above aqueous electrolytic solution, and further adding from 2 to 20 mg of sample to be measured. The electrolytic solution in which the sample has been suspended is subjected to dispersion for about 1 minute to about 3 minutes in an ultrasonic dispersion machine. The volume distribution and number distribution are calculated by measuring the volume and number of toner particles with particle diameters of not smaller than 2 μm by means of the above Coulter counter Model TA-II, using an aperture of 100 μm as its aperture. Then the values according to the present invention are determined, which are the volume-based, weight-average particle diameter (D4) determined from the volume distribution and the number-based, number-average particle diameter (D1) determined from number distribution.

The coefficient of variation in the number distribution of the toner particles is calculated from the following expression:

coefficient of variation=[S/D1]×100

wherein S represents a value of standard deviation in the number distribution of the toner particles, and D1 represents number average particle diameter (μm) of the toner particles.

In the present invention, SF-1 and SF-2 each indicating shape factors are values obtained by sampling at random 100 particles of toner by the use of FE-SEM (S-800; an electron scanning microscope manufactured by Hitachi Ltd.), introducing their image information in an image analyzer (LUZEX-III; manufactured by Nikore Co.) through an interface, and analyzing and calculating the data according to the following expression. The values obtained are defined as shape factors SF-1 and SF-2.

SF-1=(MXLNG)²/AREA×π/4×100

SF-2=(PERI)²/AREA×1/4π×100

wherein MXLNG represents an absolute maximum length of a toner particle, PERI represents a peripheral length of a toner particle, and AREA represents a projected area of a toner particle.

The shape factor SF-1 indicates the degree of sphericity of toner particles. Shape factor SF-2 indicates the degree of surface irregularity of toner particles.

From the viewpoint of more preventing the adhesion of toner onto toner carrying member and the contamination of the charging member surface in image reproduction on many sheets, the toner may preferably have the value of SF-1 of 100<SF-1 ≦160 and the value of SF-2 of 100<SF-2≦140, and may more preferably have the value of SF-1 of 100<SF-1 ≦140 and the value of SF-2 of 100<SF-2 ≦120. The use of such a toner is preferable in order to improve transfer performance while maintaining developing performance.

If SF-1 is more than 160, toner particles become less spherical and become more closely amorphous (shapeless), and the toner particles tend to be crushed in the developing assembly, so that the particle size distribution may vary or the charge quantity distribution becomes broad, tending to cause ground fog and reversal fog. Also, if SF-2 is more than 140, the transfer efficiency of toner images may also lower when the toner images are transferred from the photosensitive member to the transfer medium, and the blank areas caused by poor transfer may occur on line images. Thus, such values are not preferable.

As colorants used in the present invention, carbon black, magnetic materials, and colorants toned in black by the use of yellow, magenta and cyan colorants shown below are used as black colorants.

As a yellow colorant used are compounds typified by condensation azo compounds, isoindolinone compounds, anthraquinone compounds, azo metal complexes, methine compounds and allylamide compounds. Specifically, preferred is the use of C.I. Pigment Yellow 12, 13, 14, 15, 17, 62, 74, 83, 93, 94, 95, 97, 109, 110, 111, 128, 129, 147 and 168.

As a magenta colorant used are condensation azo compounds, diketopyropyyrole compounds, anthraquinone compounds, quinacridone compounds, basic dye lake compounds, naphthol compounds, benzimidazolone compounds, thioindigo compounds and perylene compounds. Specifically, preferred is the use of C.I. Pigment Red 2, 3, 5, 6, 7, 23, 48:2, 48:3, 48:4, 57:1, 81:1, 144, 146, 166, 169, 177, 184, 185, 202, 206, 220, 221 and 254.

As a cyan colorant, copper phthalocyanine compounds and derivatives thereof, anthraquinone compounds and basic dye lake compounds may be used. Specifically, C.I. Pigment Blue 1, 7, 15:1, 15:2, 15:3, 15:4, 60, 62 and 66 may particularly preferably be used.

These colorants may be used alone, in the form of a mixture, or in the state of a solid solution. The colorants are selected taking account of hue angle, chroma, brightness, weatherability, transparency on OHP films and dispersibility in toner particles. The colorant may preferably be used in an an amount of from 1 to 20 parts by weight based on 100 parts by weight of the binder resin.

In the case when a magnetic material is used as the black colorant, it may preferably be used in an amount of from 10 to 150 parts by weight based on 100 parts by weight of the binder resin, which is different from the amount of other colorant. In the case when such a magnetic material is used as the black colorant, the shape of the magnetic material may be octahedral, hexahedral, spherical, acicular or flaky. Those having less anisotropy such as octahedral, hexahedral, spherical or amorphous ones are preferred in view of an improvement in image density. The magnetic material may preferably have an average particle diameter of from 0.01 to 1.0 μm, more preferably from 0.2 to 0.6 pm, and still more preferably from 0.03 to 0.4 μm.

As charge control agents used in the present invention, known agents may be used. It is preferable to use charge control agents that make a toner charging speed higher and are capable of stably maintaining a constant charge quantity. When the suspension polymerization (direct polymerization) is used in the present invention to obtain the toner particles, charge control agents having neither polymerization inhibitory action nor solubilizates in the aqueous dispersion medium are particularly preferred. Such compounds specifically include, as negative charge control agents, metal compounds of salicylic acid, naphthoic acid and dicarboxylic acids or derivatives thereof, metal compounds of azo pigments or derivatives thereof, polymer type compounds having sulfonic acid or carboxylic acid in the side chain, boron compounds, urea compounds, silicon compounds, and calixarene, any of which may be used. As positive charge control agents named are Nigrosine, triphenylmethane compounds, quaternary ammonium salts, polymer type compounds having such a quaternary ammonium salt in the side chain, guanidine compounds, and imidazole compounds, any of which may be used. Any of these charge control agents may preferably be used in a amount of from 0.5 to 10 parts by weight based on 100 parts by weight of the binder resin. In the present invention, however, the addition of the charge control agent is not essential. Also in the case when non-magnetic one-component blade coating development is employed, the triboelectric charging with a blade member or sleeve member may be intentionally utilized, thus the charge control agent need not necessarily be contained in the toner particles.

When the polymerization process is used as a method for producing the toner according to the present invention, the polymerization initiator may include azo type polymerization initiators such as 2,2′-azobis-(2,4-dimethylvaleronitrile), 2,2′-azobisisobutyronitrile), 1,1′-azobis-(cyclohexane-1-carbonitrile), 2,2′-azobis-4-methoxy-2,4-dimethylvaleronitrile and azobisisobutyronitrile; and peroxide type polymerization initiators such as benzoyl peroxide, methyl ethyl ketone peroxide, diisopropylperoxy carbonate, cumene hydroperoxide, 2,4-dichlorobenzoyl peroxide and lauroyl peroxide.

The polymerization initiator may usually be used in an amount of from 0.5 to 20% by weight based on the weight of polymerizable monomers, which may vary depending on the intended degree of polymerization. The type of polymerization initiator may vary a little depending on methods for polymerization, and may be used alone or in the form of a mixture, in reference to its 10-hour half-life period temperature.

In order to control the degree of polymerization, any known cross-linking agent, chain transfer agent and polymerization inhibitor may be further added.

When the suspension polymerization is used as a method for producing the toner according to the present invention, a dispersant may be used which may include, as inorganic oxides, tricalcium phosphate, magnesium phosphate, aluminum phosphate, zinc phosphate, calcium carbonate, magnesium carbonate, calcium hydroxide, magnesium hydroxide, aluminum hydroxide, calcium metasilicate, calcium sulfate, barium sulfate, bentonite, silica, alumina, magnetic materials, and ferrite. As organic compounds named are polyvinyl alcohol, gelatin, methyl cellulose, methyl hydroxypropyl cellulose, ethyl cellulose, carboxymethyl cellulose sodium salt, and starch, which may be dispersed in an aqueous phase when used. Any of the dispersants may preferably be used in an amount of from 0.2 to 10.0 parts by weight based on 100 parts by weight of the polymerizable monomers.

As these dispersants, those commercially available may be used as they are. In order to obtain dispersed particles having a fine and uniform particle size, however, fine particles of the inorganic compound may be formed in a dispersion medium under high-speed agitation. For example, in the case of tricalcium phosphate, an aqueous sodium phosphate solution and an aqueous calcium chloride solution may be mixed under high-speed agitation, whereby a dispersant preferable for the suspension polymerization can be obtained.

In order to make the particles of these dispersants fine, 0.001 to 0.1 part by weight of surface-active agent may be used in combination. Specifically, commercially available nonionic, anionic or cationic surface-active agents can be used. For example, preferably used are sodium dodecylbenzenesulfate, sodium tetradecylsulfate, sodium pentadecylsulfate, sodium octylsulfate, sodium oleate, sodium laurate, potassium stearate and calcium oleate.

When the suspension polymerization is used as a method for producing the toner according to the present invention, the toner can be produced by a production process as described below.

A monomer composition comprising polymerizable monomers and the wax, the colorant, the charge control agent, the polymerization initiator and other additives, which are added to the polymerizable monomers and uniformly dissolved or dispersed by means of a homogenizer or an ultrasonic dispersion machine, is dispersed in an aqueous medium containing a dispersion stabilizer, by means of a conventional stirrer, a homomixer or a homogenizer. Granulation is carried out preferably while controlling the agitation speed or time so that droplets of the monomer composition can have the desired toner particle size. After the granulation, agitation may be carried out to such an extent that the state of particles is maintained and the particles can be prevented from settling by the acton of the dispersion stabilizer. The polymerization may be carried out at a polymerization temperature set at 40° C. or above, usually from 50 to 90° C. At the latter half of the polymerization, the temperature may be raised, and also the aqueous medium may be removed in part from the reaction system at the latter half of the reaction or after the reaction has been completed, in order to remove unreacted polymerizable monomers, by-products and so forth so that the running performance can be improved in the image forming method of the present invention. After the reaction has been completed, the toner particles formed are collected by washing and filtration, followed by drying. In such suspension polymerization, water may usually be used as the dispersion medium preferably in an amount of from 300 to 3,000 parts by weight based on 100 parts by weight of the monomer composition.

When the toner is produced by the suspension polymerization described above, a monomer having a higher polarity than the wax may be used, whereby the toner having the core/shell structure can be obtained.

In the present invention, the surfaces of the toner particles may preferably be coated with an inorganic fine powder so that an appropriate fluidity and chargeability can be imparted to the toner particles and also the cleaning performance can be improved and any stress from contacting members such as the photosensitive member and the charging member can be relaxed. The toner particle surfaces may preferably be coated with it in a coverage of from 5 to 99%, and more preferably from 10 to 99%. Such toner particles having the inorganic fine powder on their surfaces can also improve transfer efficiency and more prevent blank areas from occurring in character or line images.

The coverage with the inorganic fine powder on the toner particle surfaces is a value obtained by sampling at random 100 toner particles by the use of FE-SEM (S-800; a scanning electron microscope manufactured by Hitachi Ltd.), introducing their image information in an image analyzer (LUZEX-III; manufactured by Nikore Co.) through an interface, and analyzing and calculating the data obtained.

The inorganic fine powder used in the present invention may preferably have an average particle diameter not larger than 1/10 of a weight-average particle diameter of the toner particles, in view of its durability when added to the toner. The particle diameter of this inorganic fine powder refers to an average particle diameter obtained by observing the toner particles on an electron microscope. As the inorganic fine powder, for example, the following material may be used: fine powders of metal oxides such as aluminum oxide, titanium oxide, strontium titanate, cerium oxide, magnesium oxide, chromium oxide, tin oxide and zinc oxide; nitrides such as silicon nitride; carbides such as silicon carbide; metal salts such as calcium sulfate, barium sulfate and calcium carbonate; fatty acid metal salts such as zinc stearate and calcium stearate; carbon black; and silica.

Any of these inorganic fine powders may preferably be used in an amount of from 0.01 to 10 parts by weight, and more preferably from 0.05 to 5 parts by weight, based on 100 parts by weight of the toner particles. These inorganic fine powders may be used alone or may be used in combination. Inorganic fine powders having been subjected to hydrophobic treatment are more preferred.

Especially for the purpose of improving charge stability, developing performance, fluidity and storage stability of the toner, at least one inorganic fine powder may preferably be selected from fine powders of silica, aluminum oxide and titanium oxide, or double oxides thereof. Fine silica powder is more preferred. For example, such fine silica powder includes what is called dry-process silica or fumed silica produced by vapor phase oxidation of silicon halides or alkoxides and what is called wet-process silica produced from alkoxide or water glass, either of which may be used. The dry-process silica is more preferred, as having less silanol groups on the surface and inside of the fine silica powder and leaving less production residues such as Na₂O and SO₃²⁻. In the dry-process silica, it is also possible to use, in its production step, other metal halide compound such as aluminum chloride or titanium chloride together with the silicon halide to give a composite fine powder of silica with other metal oxide. The fine silica powder includes these, too.

The inorganic fine powder used in the present invention may have a BET specific surface area of 30 m²/g or more, and particularly in the range of from 50 to 400 m²/g, as measured by nitrogen adsorption according to the BET method. Such a powder gives good results. It may preferably be used in an amount of from 0.1 to 8 parts by weight, more preferably from 0.5 to 5 parts by weight, and still more preferably from 1.0 to 3.0 parts by weight, based on 100 parts by weight of the toner. For the purpose of imparting hydrophobicity and controlling chargeability, the inorganic fine powder used in the present invention may also optionally have been treated with a treating agent such as a silicone varnish, a modified silicone varnish of various types, a silicone oil, various types of modified silicone oil, a silane coupling agent, a silane coupling agent having a functional group, other organic silicon compound, or an organic titanium compound, any of which may be used alone or in combination.

In order to maintain a high charge quantity and achieve a low consumption and a high transfer efficiency, the inorganic fine powder may preferably be further treated with at least a silicone oil.

In order to improve transfer performance and/or cleaning performance, inorganic or organic closely spherical fine particles having a primary particle diameter of 50 nm or larger (preferably having a BET specific surface area smaller than 30 m²/g) may be further added. This is one of the preferred embodiments. For example, spherical silica particles, spherical polymethyl silsesquioxane particles and spherical resin particles may preferably be used.

In the toner used in the present invention, other additives may also be used so long as they substantially do not adversely affect the toner, which may include, e.g., lubricant powders such as Teflon powder, zinc stearate powder and polyvinylidene fluoride powder; abrasives such as cerium oxide powder, silicon carbide powder and strontium titanate powder; fluidity-providing agents such as titanium oxide powder and aluminum oxide powder; anti-caking agents; and conductivity-providing agents such as carbon black powder, zinc oxide powder and tin oxide powder. Reverse-polarity organic particles and inorganic particle may also be used in a small quantity as a developability improver.

Other than the suspension polymerization previously described, the toner according to the present invention may be produced by a method of what is called the pulverization process, in which the binder resin, the wax, the colorant, the charge control agent and so forth are melt-kneaded by means of a pressure kneader or extruder or a media dispersion machine to make them uniformly dispersed, thereafter the kneaded product is cooled and then collided against a target by a mechanical means or in a jet stream so as to be finely pulverized to have the desired toner particle diameter, and then the pulverized product is further brought to a classification step to make its particle size distribution sharp, producing toner particles; as well as the method as disclosed in Japanese Patent Publication No. 56-13945, in which a molten mixture is atomized in the air by means of a disk or a multiple fluid nozzle to obtain spherical toner particles; a dispersion polymerization method in which toner particles are directly produced using an aqueous organic solvent capable of dissolving polymerizable monomers and not capable of dissolving the resulting polymer; and an emulsion polymerization method such as soap-free polymerization in which toner particles are produced by direct polymerization of polymerizable monomers in the presence of a water-soluble polar polymerization initiator.

In the present invention, a releasability may preferably be imparted to the photosensitive member surface, and the photosensitive member surface may preferably have a contact angle to water of 85 degrees or more, more preferably 90 degrees or more. The fact that the photosensitive member surface has a high contact angle shows that the photosensitive member surface has a high releasability, which is effective for enabling the transfer residual toner to be lessened very much, so that the load in the cleaning step can be greatly decreased and the faulty cleaning can be more surely prevented from occurring.

The image forming method of the present invention effective by works especially when a photosensitive member the surface of which is mainly formed of a polymeric binder is used; for example, when a protective film mainly formed of a resin is provided on an inorganic photosensitive member comprised of a material such as selenium or amorphous silicon, or when a function-separated photosensitive member has as a charge transport layer a surface layer formed of a charge-transporting material and a resin, and when the protective layer as described above is further provided thereon. As means for imparting releasability to such a surface layer, it is possible (1) to use a material with a low surface energy in the resin itself constituting the film, (2) to add an additive capable of imparting water repellency or lipophilicity, and (3) to disperse in a powdery form a material having a high releasability. In the case of (1), the object is achieved by introducing into the resin structure a fluorine-containing group, a silicone-containing group or the like. In the case of (2), a surface active agent or the like may be used as the additive. In the case of (3), the object can be achieved by dispersing a compound containing fluorine atoms, i.e., a fluorine-containing compound such as polytetrafluoroethylene, polyvinylidene fluoride or carbon fluoride.

Employment of such means can make the surface of the photosensitive member have a contact angle to water of 85 degrees or more. If the photosensitive member surface has a contact angle to water of less than 85 degrees, the toner and the toner carrying member tend to deteriorate as a result of running.

Of these means, the means (3) is preferred, and it is preferred to use a fluorine-containing compound such as polytetrafluoroethylene as a powder with releasability, and disperse it in the outermost surface layer of the photosensitive member.

In order to incorporate such powder into the surface portion, a layer comprising a binder resin with the powder dispersed therein may be provided on the outermost surface of the photosensitive member. Alternatively, in the case of an organic photosensitive member originally mainly comprised of a resin, the powder may be merely dispersed in the outermost layer without anew providing the surface layer.

The powder may preferably be added to the surface layer in an amount of from 1 to 60% by weight, and more preferably from 2 to 50% by weight, based on the total weight of the surface layer. Its addition in an amount less than 1% by weight can not well lessen the transfer residual toner, can not make the transfer residual toner removable in a sufficient cleaning efficiency, and can be less effective for preventing ghost. Its addition in an amount more than 60% by weight is not preferable since the film strength may lower or the amount of light incident on the photosensitive member may greatly decrease. The powder may have a particle diameter of 1 μm or smaller, and preferably 0.5 μm or smaller, in view of image quality. If it has a particle diameter larger than 1 μm, line images may have too poor sharpness to be tolerable in practical use, because of scattering of incident light.

One of preferred embodiments of the photosensitive member used in the present invention will be described below.

It basically comprises a conductive substrate, and a photosensitive layer functionally separated into a charge generation layer and a charge transport layer.

As the conductive substrate, a cylindrical member or a belt may be used, comprising a metal such as aluminum or stainless steel; a plastic having a coat layer formed of an aluminum alloy, an indium oxide-tin oxide alloy or the like; a paper or plastic impregnated with conductive particles; or a plastic having a conductive polymer.

On the conductive substrate, a subbing layer may be provided for the purposes of, e.g., improving adhesion of a photosensitive layer, improving coating properties, protecting the substrate, covering defects on the substrate, improving properties of charge injection from the substrate and protecting the photosensitive layer from electrical breakdown. The subbing layer may be formed of a material such as polyvinyl alcohol, poly-N-vinyl imidazole, polyethylene oxide, ethyl cellulose, methyl cellulose, nitrocellulose, an ethylene-acrylic acid copolymer, polyvinyl butyral, phenol resin, casein, polyamide, copolymer nylon, glue, gelatin, polyurethane or aluminum oxide. The subbing layer may usually be in a thickness of from 0.1 to 10 μm, and preferably from 0.1 to 3 μm.

The charge generation layer may preferably be provided on the subbing layer. The charge generation layer is formed by applying a solution prepared by dispersing a charge-generating material in a suitable binder, or by vacuum deposition of the charge-generating material. The charge-generating material includes azo pigments, phthalocyanine pigments, indigo pigments, perylene pigments, polycyclic quinone pigments, squarilium dyes, pyrylium salts, thiopyrylium salts, triphenylmethane dyes, selenium, and amorphous silicon. In particular, phthalocyanine pigments are preferred in order for the sensitivity of the photosensitive member to be adjusted to the sensitivity suitable for the present invention. The binder can be selected from a vast range of binder resin, including, e.g., resins such as polycarbonate resins, polyester resins, polyvinyl butyral resins, polystyrene resins, acrylic resins, methacrylic resins, phenol resins, silicone resins, epoxy resins and vinyl acetate resins. The binder contained in the charge generation layer may be in an amount not more than 80% by weight, and preferably from 0 to 40% by weight. The charge generation layer may preferably have a thickness of 5 μm or smaller, and particularly from 0.05 to 2 μm.

The charge transport layer may preferably be superposed on the charge generation layer. The charge transport layer has the function to receive charge carriers from the charge generation layer in the presence of an electric field and transport them. The charge transport layer is formed by applying a solution prepared by dispersing a charge-transporting material in a solvent optionally together with a binder resin, and usually may preferably have a layer thickness of from 5 to 40 μm. The charge-transporting material may include polycyclic aromatic compounds having in the backbone chain or side chain a structure such as biphenylene, anthracene, pyrene or phenanthrene; and nitrogen-containing cyclic compounds such as indole, carbazole, oxadiazole and pyrazoline; as well as hydrozone compounds, styryl compounds, selenium, selenium-tellurium, amorphous silicone, and cadmium sulfide. The binder resin in which the charge-transporting material is dispersed may include resins such as polycarbonate resins, polyester resins, polymethacrylates, polystyrene resins, acrylic resins and polyamide resins; and organic photoconductive polymers such as poly-N-vinyl carbazole and polyvinyl anthracene.

A protective layer may be provided as a surface layer. For the protective layer, resins such as polyesters, polycarbonates, acrylic resins, epoxy resins, phenol resins, and cured products of any of these resins may be used alone or in combination.

In the resin of the protective layer, conductive fine particles may be dispersed. The conductive fine particles may include, e.g., particles of metals or metal oxides. Preferably, they are ultrafine particles of zinc oxide, titanium oxide, tin oxide, antimony oxide, indium oxide, bismuth oxide, tin oxide-coated titanium oxide, tin-coated titanium oxide, antimony-coated tin oxide or zirconium oxide. These may be used alone or may be used in the form of a mixture of two or more. In general, when particles are dispersed in the protective layer, the particles must have a particle diameter smaller than the wavelength of incident light in order to prevent dispersed particles from causing scattering of the incident light. Conductive or insulating particles dispersed in the protective layer in the present invention may preferably have particle diameters of 0.5 μm or smaller. Such particles in the protective layer may preferably be in a content of from 2 to 90% by weight, and more preferably from 5 to 80% by weight, based on the total weight of the protective layer. The protective layer may preferably have a layer thickness of from 0.1 to 10 μm, and more preferably from 1 to 7 μm.

The surface layer may be formed by applying a resin dispersion with spray coating, beam coating or dip coating.

The developing step in the image forming method of the present invention is conducted on the condition that the toner layer on the toner carrying member comes into contact with the photosensitive member surface.

In the case of the one-component developer, a method may be used in which an elastic roller is used as the toner carrying member and a toner layer formed by applying the toner on the surface of the elastic roller is brought into contact with the photosensitive member surface. Here, the toner may be either of magnetic and non-magnetic, and it is important that the toner layer and the photosensitive member surface come into contact with each other. The toner carrying member substantially comes into contact with the photosensitive member surface, and this means that the toner carrying member comes into contact with the photosensitive member when the toner layer is removed from the toner carrying member. Here, in order to obtain images free of the edge effect with the assistance of an electric field acting between the photosensitive member surface and the toner carrying member facing the the photosensitive member surface through the toner, the elastic roller is required to have a potential on or near its surface and the electric field should be formed between the photosensitive member surface and the elastic roller surface. Hence, the elastic rubber of the elastic roller may be resistance-controlled in a medium-resistance region so as to keep the electric field while preventing electrical contact with the photosensitive member surface, or a thin-layer insulating layer may be provided on the surface of a conductive roller; either method may be used. The system may also bo so constituted that a conductive roller is provided with a conductive resin sleeve coated with an insulating substance on its outer side facing the photosensitive member surface or with a conductive layer on the inner side of an insulating sleeve not facing the photosensitive member surface. Such a constitution is also possible that a rigid-body roller is used as the toner carrying member and a flexible material such as a belt is used as the photosensitive member. It is preferred that the electrical resistance of the developing roller as the toner carrying member is in a range of 10² to 10⁹ ohms.

The toner carrying member according to the present invention may specifically comprise a mandrel or cylindrical sleeve made of a metal such as aluminum or stainless steel, and provided on its surface an elastic layer formed of a material having an elasticity as exemplified by a rubber such as silicone rubber or urethane rubber, an elastomer or a foamed resin.

For the purposes of imparting chargeability to the toner, preventing the toner from sticking and protecting the inside, the elastic layer of the toner carrying member may contain a resistance modifier such as carbon black or may be provided with a coat layer by the use of a coating agent such as polyamide resin, urethane resin or silicone resin or a tube. In this instance, the toner carrying member may preferably be controlled to have an electrical resistance within the range of from 10² to 10⁹ ohms.

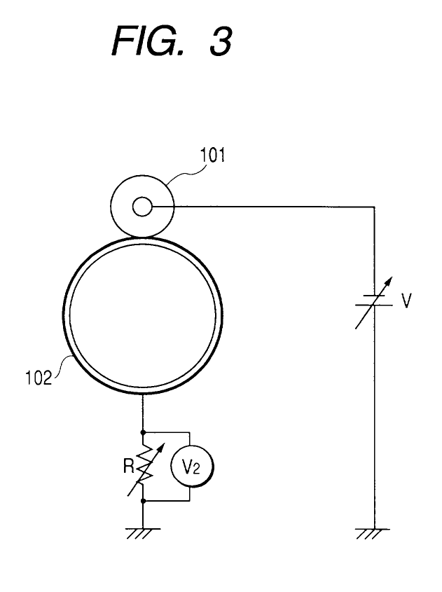

The electrical resistance of the toner carrying member is measured in the following way: As shown in FIG. 3, an aluminum roller 101 of 16 mm diameter is brought into contact with a developing roller 102 at a contact load of 4.9 N (500 g), and the aluminum roller 101 is rotated at 2 r.p.s. Next, a DC voltage of V1= 400 V is applied to the developing roller 102, and a variable resistance R is provided on its earth side. A voltage V2 on both ends is measured while adjusting the resistance values of the variable resistance R in accordance with the developing roller 102, where the electrical current values are calculated to calculate the electrical resistance of the developing roller 102. The value obtained is indicated as the electrical resistance of the toner carrying member.

When a one-component contact development system is used, the toner carrying member that carries the toner on its surface may be rotated in the same direction as the surface movement of the photosensitive member, or may be rotated in the opposite direction. When it is rotated in the same direction, it may preferably be rotated in a peripheral speed ratio of more than 100% with respect to the peripheral speed of the photosensitive member. If it is not more than 100%, a low image quality level may result in. With an increase in the peripheral speed ratio, the quantity of the toner fed to the developing zone increases, and the toner is more frequently attached to and detached from the latent image, where the toner is repeatedly scraped off at the unnecessary part and imparted to the necessary part, so that an image faithful to the electrostatic latent image can be formed. Specifically, the movement speed of the toner carrying member surface may preferably be 1.05 to 3.0 times the movement speed of the photosensitive member surface.

A transfer process that can be applied to the image forming method of the present invention will be specifically described below.

In the transfer step, a contact transfer system may preferably be used in which the toner image is electrostatically transferred to the transfer medium while bringing a transfer means into contact with the photosensitive member surface, interposing the transfer medium between them. The transfer means may preferably be brought into contact with the photosensitive member surface at a linear pressure of 2.9 N/m (3 g/cm) or higher, and more preferably from 9.8 to 490 N/m (10 to 500 g/cm). If the linear pressure as contact pressure is lower than 2.9 N/m (3 g/cm), transport aberration of transfer mediums and faulty transfer tend to occur undesirably. A too high contact pressure may cause deterioration of the photosensitive member surface or adhesion of the toner, resulting in melt-adhesion of the toner to the photosensitive member surface.

As the transfer means used in the contact transfer step, an assembly having a transfer roller or a transfer belt may be used. The transfer roller may be comprised of at least a mandrel and a conductive elastic layer covering the mandrel. The conductive elastic layer may preferably be made of an elastic material having a volume resistivity of about 10⁶ to 10¹⁰Ω•cm, such as urethane resin and EPDM with a conductive material such as carbon dispersed therein.

The present invention is especially effectively used in an image forming apparatus comprising a photosensitive member whose surface layer is formed of an organic compound. That is, when the organic compound forms the surface layer of the photosensitive member, the binder resin contained in the toner particles is more liable to adhere to the surface layer than other cases where an inorganic material is used, bringing about such a technical problem that the transfer performance tends to more lower. Thus, the effect produced by the high transfer performance attributable to the toner used in the present invention can be more remarkable.

The present invention is effectively applied especially to image forming apparatus having a small-diameter drum type photosensitive member having a diameter of 50 mm or smaller. That is, in the case of the small-diameter photosensitive drum, the pressure concentrates at the contact portion of the contact member under a like linear pressure. The like phenomenon is considered to be seen also in belt-like photosensitive members. The present invention is effective also in image forming apparatus making use of a belt photosensitive member which forms a curvature radius of 25 mm or smaller at the contact portion.

In the present invention, the total charge quantity of the toner may preferably be controlled at the time of development using the toner. Accordingly, the surface of the toner carrying member according to the present invention may preferably be covered with a resin layer in which conductive fine particles and/or a lubricant has/have been dispersed.

As charging methods, known corona charging called corotron or scrorotron may be used. Besides, a method making use of pin electrodes may be used. Contact charging may also be used which is a method of charging the photosensitive member surface by bringing a charging member into contact with it.

The present invention is particularly effective in contact charging methods in which a charging means is brought into contact with a photosensitive member surface. That is, as compared with non-contact corona discharge where the charging means is in non-contact with the photosensitive member surface, the contact charging method has such technical problems that the photosensitive member surface is liable to deteriorate and, from the viewpoint of running performance, an increase in transfer residual toner that is caused by a lowering of transfer performance brings cleaning performance into a severer condition. Thus, the effect produced by the high transfer performance attributable to the toner used in the present invention can be more remarkable.

As process conditions preferable when a charging roller is used as the contact charging member, the charging roller may preferably be set at a contact pressure of from 4.9 to 490 N/m (5 to 500 g/cm), and more preferably from 9.8 to 392 N/m (10 to 400 g/cm), and also a DC voltage may preferably be applied in order to make the polarity of the transfer residual toner have uniformly the same polarity as the photosensitive member so that the transfer residual toner can be collected at the time of development with ease. When a voltage produced by superimposing an AC voltage on the DC voltage is used, it is preferable to superimpose on the DC voltage an AC voltage having a peak-to-peak voltage of less than 2×Vth (V) [Vth: discharge starting voltage (V) in the application of DC voltage].

As other contact charging means, there is a method making use of a charging blade or a conductive brush. These contact charging means have the effect of making it unnecessary to apply a high voltage or generating less ozone.

For the contact charging member, in the case of the roller or the blade, a conductive metal such as iron, copper or stainless steel, a carbon-dispersed resin, or a metal powder or metal oxide powder-dispersed resin may be used as its conductive substrate. In the case of the blade, it may have the shape of a rod or a plate. An elastic roller constituted of a conductive substrate and provided thereon an elastic layer, a conductive layer and a resistance layer may be used.

The elastic layer may be formed of a rubber such as chloroprene rubber, isoprene rubber, EPDM rubber, polyurethane rubber, epoxy rubber or butyl rubber, or a spongy which is a foam of any of these rubbers; or a thermoplastic elastomer such as a styrene-butadiene thermoplastic elastomer, a polyurethane thermoplastic elastomer, a polyester thermoplastic elastomer or an ethylene-vinyl acetate thermoplastic elastomer.

The conductive layer may preferably have a volume resistivity of 10⁷Ω•cm or below, and preferably from 10¹ to 10⁶•cm. For example, a metal-deposited film, a conductive particle-dispersed resin or a conductive resin may be used to form the conductive layer. As specific examples, the following are named: deposited films of conductive metals such as aluminum, indium, nickel, copper and iron; conductive-particle-dispersed resins prepared by dispersing conductive particles such as carbon, aluminum, nickel or titanium oxide particles in a resin such as urethane, polyester, a vinyl acetate-vinyl chloride copolymer or polymethyl methacrylate; and conductive resins such as quaternary ammonium salt-containing polymethyl methacrylate, polyvinyl aniline, polyvinyl pyrrole, polydiacetylene and polyethyleneimine.

The resistance layer may preferably be a layer having a volume resistivity of 10⁶ to 10¹²Ω•cm. A semiconductive resin or a conductive-particle-dispersed insulating resin may be used to form the resistance layer. As the semiconductive resin, ethyl cellulose, nitro cellulose, methoxymethylated nylon, ethoxymethylated nylon, copolymer nylon, polyvinyl pyrrolidone or casein may be used, for example. The conductive-particle-dispersed insulating resin includes, e.g., resins prepared by dispersing conductive particles such as carbon, aluminum, indium oxide or titanium oxide particles in a small quantity in an insulating resin such as urethane, polyester, a vinyl acetate-vinyl chloride copolymer or polymethyl methacrylate.

The conductive brush serving as the contact charging member may be comprised of a fiber commonly used and a conductive material dispersed therein for the purpose of regulating resistance. As the fiber, commonly known fibers may be used, including, e.g., nylon, acrylic, rayon, polycarbonate or polyester. As the conductive material, commonly known conductive materials may be used, including, e.g., conductive metals such as copper, nickel, iron, aluminum, gold and silver; metal oxides such as iron oxide, zinc oxide, tin oxide, antimony oxide and titanium oxide; and conductive powders such as carbon black. These conductive powders may be optionally subjected to surface treatment for the purpose of imparting hydrophobicity or regulating resistance. When used, these conductive powders are selected taking account of dispersibility and productivity.

The contact charging brush may have a fiber thickness of from 1 to 20 deniers (a fiber diameter of from about 10 to 500 μm), a fiber length of from 1 to 15 mm and a brush density of from 10,000 to 300,000 threads per square inch (1.5×10⁷ to 4.5×10⁸ threads per square meter), and such a brush may preferably be used.

The image forming method of the present invention will be described with reference to accompanying drawings.

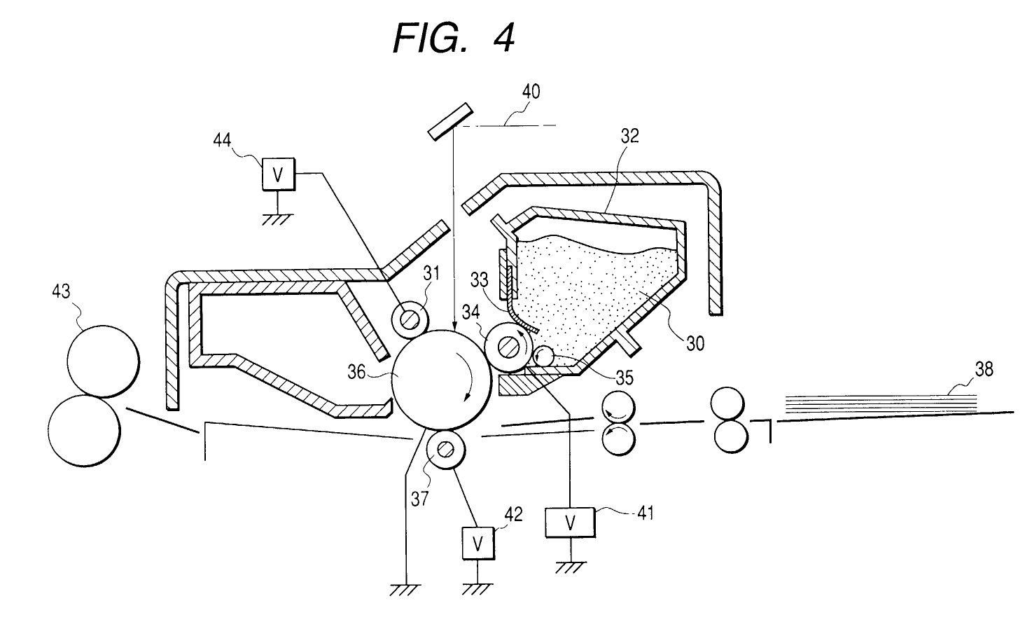

FIG. 4 diagrammatically illustrates, as an example for carrying out the image forming method of the present invention, an image forming apparatus having a process cartridge from which a cleaning unit having a cleaning member such as a cleaning blade has been removed.

A photosensitive member 36 is electrostatically charged by means of a charging roller 31 serving as the contact charging member, and image areas are exposed to laser light 40 to form an electrostatic latent image. A toner 30 held in a developing assembly 32 is applied onto a developer carrying member 34 by means of a toner coating roller 35 and a coating blade 33, and the electrostatic latent image formed on the photosensitive member 36 is developed by reverse development, by bringing a toner layer formed on the developer carrying member 34 into contact with the surface of the photosensitive member 36 to form a toner image on the photosensitive member 36. To the developer carrying member 34, at least a DC bias is applied through a bias applying means 41. The toner image on the photosensitive member 36 is transferred onto a transfer medium 38 transported to the transfer zone, by means of a transfer roller 37, serving as the transfer means, to which a bias is applied through a bias applying means 42. The toner image transferred onto the transfer medium is fixed through a heat-and-pressure fixing means 43 having a heating roller and a pressure roller.

The transfer residual toner, remaining on the photosensitive member 36 after the transfer step, is transported to the place where the charging roller 31 stands, without the step of cleaning by a cleaning member such as a cleaning blade. The photosensitive member 36 having the transfer residual toner is again charged by means of the charging roller 31, and after the charging, exposed to laser light 40, so that an electrostatic latent image is formed. On the photosensitive member 36 having the transfer residual toner, the electrostatic latent image is developed by the toner carried on the developer carrying member 34 and simultaneously the transfer residual toner is collected to the toner carrying member 34. A toner image formed on the photosensitive member 36 after the cleaning-at-development step is transferred onto a transfer medium 38 transported to the transfer zone, by means of the transfer roller 37. After the transfer step, the photosensitive member 36 is again electrostatically charged by means of the charging roller 31. The same process is repeated thereafter.

In the reverse development, as developing conditions preferable for carrying out the cleaning-at-development, the dark-portion potential (Vd) and light-portion potential (V1) on the surface of the photosensitive member and the direct bias (Vdc) applied to the toner carrying member are preferably set so as to satisfy the following relationship:

|Vd−Vdc|>|V1−Vdc|

More preferably, the value of |Vd−Vdc| be greater than the value of |V1−Vdc| by 10 V or more.

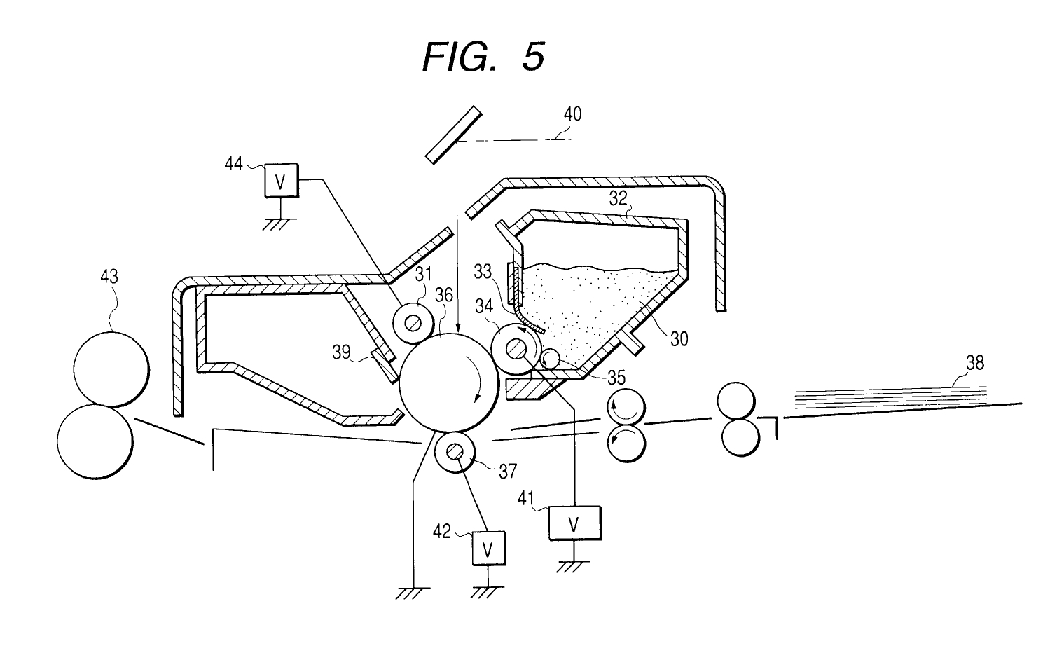

FIG. 4 shows the image forming apparatus of the cleaning-at-development system, in which the photosensitive member surface is simultaneously cleaned at the time of development without providing any cleaning member for removing the transfer residual toner remaining on the photosensitive member between the transfer zone and the charging zone and between the charging zone and the developing zone. In contrast, FIG. 5 shows an image forming apparatus of the cleaning-before-development system, in which the cleaning step is provided before the developing step.

In FIG. 5, constituent members common to those in FIG. 4 are denoted by the like reference numerals.

The image forming apparatus shown in FIG. 5 has a blade-like cleaning member 39 provided in contact with the surface of the photosensitive member 36 between the transfer zone shared with a transfer roller 37 and the charging zone shared with a charging roller 31. The transfer residual toner remaining on the photosensitive member 36 after the step of transfer is scraped off by the cleaning member 39 and collected by a cleaner. The photosensitive member 36 from the surface of which the transfer residual toner has been removed is again electrostatically charged by the charging roller 31 and is, after charged, exposed to laser light 40, so that an electrostatic latent image is formed. The electrostatic latent image on the photosensitive member 36 is developed by the toner carried on the developer carrying member 34. A toner image formed on the photosensitive member 36 after the developing step is transferred onto a transfer medium 38 transported to the transfer zone. After the transfer step, the photosensitive member 36 is cleaned by the cleaning member 39 to remove the transfer residual toner, and thereafter again electrostatically charged by means of the charging roller 31. A similar process is repeated thereafter.

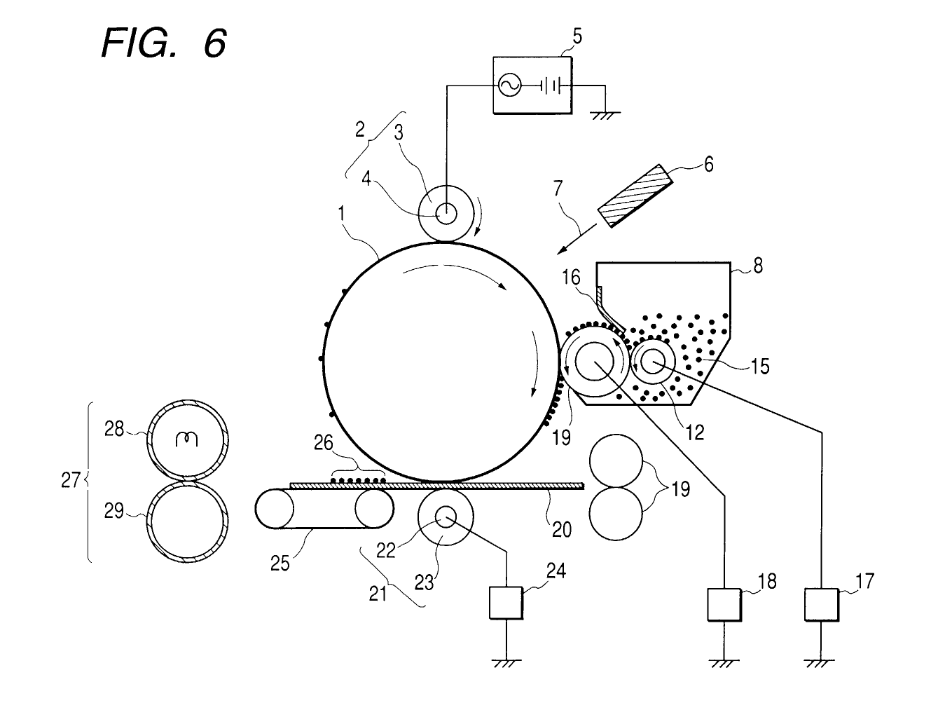

FIG. 6 illustrates another example of the image forming apparatus, in which the toner can be fed to a developing sleeve serving as the toner carrying member and in addition the toner having participated in the development can be smoothly stripped off the developing sleeve.

In FIG. 6, reference numeral 1 denotes a photosensitive drum, around which a contact charging means primary charging roller 2, a developing means developing assembly 8, a transfer charging roller 21 as a contact transfer means and a resistor roller 19 are provided. Then, the photosensitive drum 1 is electrostatically charged to, e.g., −700 V by means of the primary charging roller 2. Voltage applied by a bias applying means 5 is DC voltage which is, e.g., −3,500 V. Then, the photosensitive drum 1 is exposed to laser light 7 emitted from a laser light generator 6 to form a digital electrostatic latent image. The electrostatic latent image on the the photosensitive drum 1 is developed by a non-magnetic one-component developer (toner), and is transferred onto a transfer medium 20 by means of the transfer roller 21 to which a bias voltage is applied through a bias applying means 24. The transfer roller is brought into contact with the photosensitive drum 1 through the transfer medium 20. The transfer medium 20 holding a toner image 26 is transported on a transfer belt 25 to a heat-and-pressure fixing assembly 27 having a heat roller 28 and a pressure roller 29, and fixed to the transfer medium 20.

The charging roller 2 is basically constituted of a mandrel 4 in its center and a conductive elastic layer that forms its periphery.

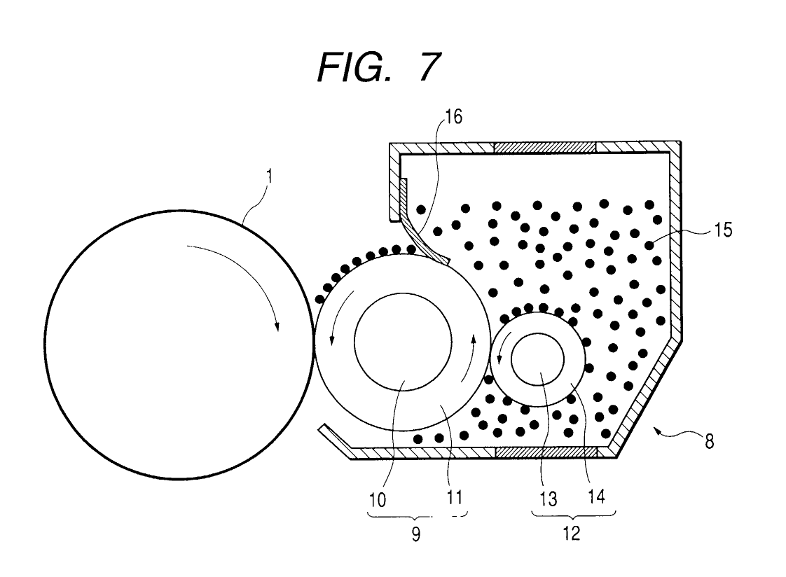

The developing assembly 8 is, as shown in FIGS. 6 and 7, provided with the developing sleeve serving as the toner carrying member, comprised of a mandrel 10 to which a bias voltage is applied through a bias applying means 18 and an elastic roller 9 having an elastic layer 11. Inside the developing assembly 8, a toner coating roller 12 is provided which has a mandrel 13 to which a bias voltage is applied through a bias applying means 17 and an elastic layer 14. As a member (toner layer thickness regulation member) for regulating the quantity of the toner transported while being attracted onto the developing sleeve 9, a toner regulating blade 16 is provided so that the quantity (or layer thickness) of the toner transported to the developing zone can be controlled in accordance with a pressure at which the toner regulating blade 16 is brought into touch with the developing sleeve 9. In the developing zone, a DC development bias is applied at least to the developing sleeve 9, and the toner layer on the developing sleeve comes into contact with the photosensitive drum 1 surface and is moved onto the photosensitive drum 1 in accordance with the electrostatic latent image to form a toner image thereon.

To carry out the cleaning-at-development, a feed bias voltage of from 100 to 900 V may preferably be applied from the bias applying means 17 and a development bias voltage of from 100 to 900 V from the bias applying means 18, when the photosensitive drum 1 has a light-portion potential of from 0 to 250 V and a dark-portion potential of from 300 to 1000 V. Also, the feed bias voltage applied from the bias applying means 17 may preferably be higher by 10 to 40 V as an absolute value, than the development bias voltage applied from the bias applying means 18. This is preferable because the feeding of the non-magnetic toner 15 to the developing sleeve 9 and the stripping of the non-magnetic toner from the developing sleeve 9 can be made smooth.

In view of the feeding and stripping of the non-magnetic toner, it is preferable for the toner coating roller 12 to be rotated in the same direction as the rotational direction of the developing sleeve 9 so that their both surfaces move in the counter direction each other as shown in arrows in FIG. 7.

In the image forming apparatus shown in FIGS. 4 to 7, employed is an image forming method of the type the toner image formed on the image bearing member is directly transferred to a recording medium (transfer medium) without the use of any intermediate transfer member.

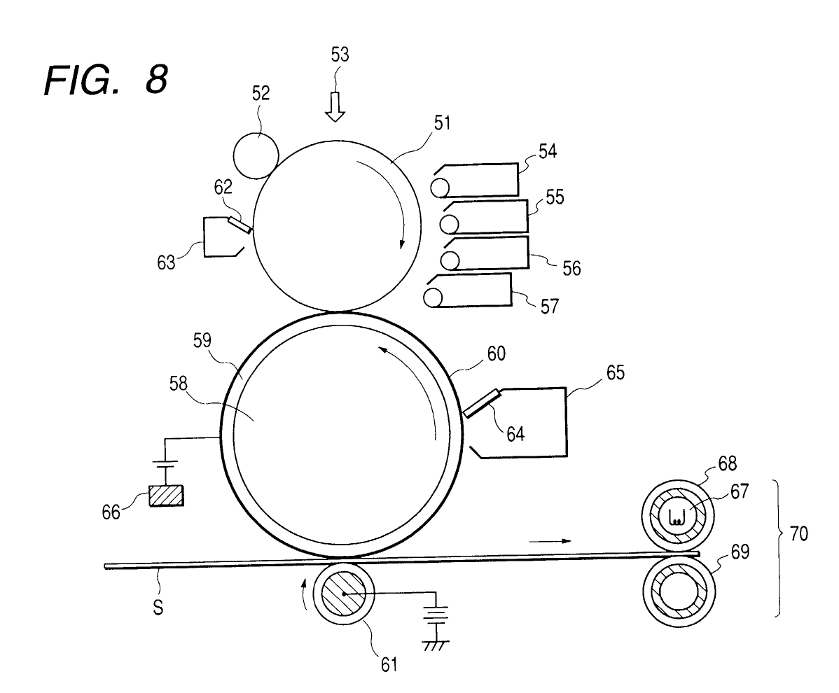

An image forming method in which the toner image formed on the image bearing member is primarily transferred to an intermediate transfer member and the toner image transferred onto the intermediate transfer member is secondarily transferred to the recording medium, will be describe below with reference to an image forming apparatus shown in FIG. 8.

As shown in FIG. 8, by means of a charging roller 52 rotatable in contact with a photosensitive drum 51 serving as the image bearing member, the photosensitive drum 51 is made to have a surface potential thereon, and an electrostatic latent image is formed by an exposure means 53. The electrostatic latent image is developed by means of developing assemblies 54, 55, 56 and 57 of one-component contact development systems by the use of four color toners, i.e., magenta, cyan, yellow and black toners, to form a full-color toner image. At the time of development, any one of the developing assemblies 54, 55, 56 and 57 is moved and the toner carrying member of the developing assembly is brought into contact with the surface of the photosensitive drum 51 to carry out development. After the development, the developing assembly is moved back to the original position, so that the toner carrying member comes apart from the surface of the photosensitive drum 51. This operation is repeated for each developing assembly. The toner image is transferred color by color onto the intermediate transfer member 58, and this is repeated plural times, so that a multiple toner image is formed.

A drum-like member is used as the intermediate transfer member 58, which may be provided with a holding member stretched over its periphery or may be comprised of a substrate and provided thereon an elastic layer (e.g., nitrile butadiene rubber) in which a conductivity-providing material as exemplified by carbon black, zinc oxide, tin oxide, silicon oxide or titanium oxide has been thoroughly dispersed. A belt-like intermediate transfer member may also be used.

The intermediate transfer member 58 may preferably be a drum-like member whose elastic layer 60 formed on a support member 59 has a hardness of from 10 to 50 degrees (JIS K-6301), or, in the case of the belt-like intermediate transfer member, be constituted of a support member with an elastic layer having this hardness at the part where the toner image is transferred to the transfer medium (recording medium).

The toner image is transferred from the photosensitive drum 51 to the intermediate transfer member by transfer electric currents produced by applying a bias voltage from a power source 66 to a mandrel 59 serving as the support member of the intermediate transfer member 58. Corona discharging or roller charging from the back of the holding member or belt may also be utilized.

The multiple toner image on the intermediate transfer member is transferred in a lump on the recording medium S by a transfer means 61. As the transfer means, a corona charging assembly or a contact electrostatic transfer means making use of a transfer roller or a transfer belt may be used.

The recording medium S having the multiple toner image is passed through a contact nip formed between a fixing roller 68 and a pressure roller of a heat-fixing assembly 70, so that the toner image is fixed to the recording medium S. The heat-fixing assembly 70 has the fixing roller 68 as a fixing member having a heating element 67 in its inside, and the pressure roller 69 comes into pressure contact with the fixing roller 68.

In FIG. 8, reference numeral 63 denotes a cleaner (a first cleaning means) having a cleaning member 62 for removing the toner remaining on the surface of the photosensitive drum 51 after the primary transfer. The cleaning member 62 is in contact with the surface of the photosensitive drum 51. Reference numeral 65 denotes a cleaner (a second cleaning means) having a cleaning member 64 for removing the toner remaining on the surface of the intermediate transfer member after the secondary transfer.

In the case of the cleaning-at-development system, the cleaner as the first cleaning means is unnecessary, and is detached from the image forming apparatus.

### EXAMPLES

The present invention will be specifically described below by giving Examples. The present invention is by no means limited to these.

Properties of waxes used in Examples and Comparative Examples of the present invention are summarized in Table 1 together with the results of measurement by DSC and the results of measurement by ¹³C-NMR.

In Table 1, Waxes 1 to 6 and Comparative Waxes 7 to 10 are waxes produced by copolymerization of α-monoolefinic hydrocarbons with ethylene. Comparative Wax 1 is polyethylene wax; Comparative Wax 2, polypropylene wax; Comparative Wax 3, a wax formed of an ethylene-propylene copolymer (copolymerization ratio: 90:10); Comparative Wax 4, a wax formed of a propylene-ethylene copolymer (copolymerization ratio: 90:10); Comparative Wax 5, paraffin wax; and Comparative Wax 6, ester wax.

Polymerization Toner

Production Example 1

Into 710 g of ion-exchanged water held in a 2-liter four-necked flask, 450 g of an aqueous 0.1M-Na₃PO₄ solution was introduced, and the mixture was heated to 60° C., followed by stirring at 12,000 r.p.m. using a high-speed stirrer TK-type homomixer (manufactured by Tokushu Kika Kogyo Co., Ltd.). Then, 68 g of an aqueous 1.0M-CaCl₂ solution was added thereto little by little to obtain an aqueous medium containing a fine-particle, sparingly water-soluble dispersion stabilizer.

Meanwhile, as a disperse phase (dispersoid), the following was prepared.

| | | (by weight) |
|---|---|---|
| Monomers: | Styrene | 165 parts |
| | 2-Ethylhexyl acrylate | 35 parts |
| Colorant: | Carbon black (BET specific | 15 parts |
| | surface area: 60 m²/g; oil | |
| | absorption: 115 ml/100 g) | |
| Charge control agent: | Salicylic acid metal compound | 2 parts |
| Polar resin: | Saturated polyester (acid value: | 10 parts |
| | KOH/g; peak molecular weight: | |
| | 7,000) | |
| Release agent: | Wax 1 | 30 parts |

A mixture of the above materials was heated to 60° C. and uniformly dissolved, and was dispersed for 3 hours by means of an attritor (manufactured by Mitsui Mining and Smelting Co., Ltd.). In the mixture obtained, 10 parts by weight of a polymerization initiator 2,2′-azobis(2,4-dimethylvaleronitrile) was dissolved. Thus, a polymerizable monomer composition was prepared.

The polymerizable monomer composition obtained was introduced into the above aqueous medium, followed by stirring at 12,000 r.p.m. for 10 minutes at 60° C. in an atmosphere of nitrogen by means of the TK-type homomixer, to carry out granulation of the polymerizable monomer composition. Thereafter, the reaction was carried out at the same temperature for 5 hours while stirring the composition with paddle stirring blades (50 r.p.m.), and thereafter the temperature was raised to 80° C., where the reaction was further carried out for 5 hours. After the polymerization reaction was completed, the residual monomers were evaporated under reduced pressure, the reaction product was cooled, and thereafter hydrochloric acid was added to dissolve away the dispersion stabilizer, followed by filtration, washing with water and drying to obtain black suspension particles having a weight average particle diameter of about 6.8 μm in a sharp particle size distribution.

To 100 parts by weight of the cyan toner particles thus obtained, 2.0 parts by weight of hydrophobic silica having a specific surface area of 140 m²/g as measured by the BET method was externally added to obtain Polymerization Toner 1.

Physical properties of the toner thus obtained are shown in Table 2.

The wax in Polymerization Toner 1 was, as shown in FIG. 2A, dispersed in a substantially spherical form while standing not mutually dissolved with the binder resin.

Polymerization Toner

Production Examples 2 and 3

Polymerization Toners 2 and 3 were produced in the same manner as in Polymerization Toner Production Example 1 except that Wax 1 was replaced with Waxes 2 and 3, respectively.

Physical properties of the toners thus obtained are shown in Table 2.

Polymerization Toner

Production Example 4

Polymerization Toner 4 was produced in the same manner as in Polymerization Toner Production Example 1 except that Wax 1 was replaced with Wax 4 and as the charge control agent the salicylic acid metal compound was replaced with an azo pigment metal compound.

Physical properties of the toner thus obtained are shown in Table 2.

Polymerization Toner

Production Examples 5 and 6

Polymerization Toners 5 and 6 were produced in the same manner as in Polymerization Toner Production Example 4 except that the quantities of the 0.1M-Na₃PO₄ solution and aqueous 1.0M-CaCl₂ solution were controlled so as to produce toners with different particle sizes.

Physical properties of the toners thus obtained are shown in Table 2.

Comparative Polymerization Toner

Production Examples 1 to 10

Comparative Polymerization Toners 1 to 10 were produced in the same manner as in Polymerization Toner Production Example 4 except that Wax 4 was replaced with Comparative Waxes 1 to 10, respectively.

Physical properties of the toners thus obtained are shown in Table 2.

Pulverization Toner Production Example 1

| | | |
|---|---|---|
| Resin: | Styrene-butyl acrylate copolymer | 100 parts |
| | (weight-average molecular weight: | |
| | about 300,000; Tg: 60° C.) | |
| Colorant: | Carbon black (BET specific surface | 7.5 parts |
| | area: 60 m²/g; oil absorption: 115 | |
| | ml/100 g) | |
| Charge control agent: | Salicylic acid metal compound | 2 parts |
| Release agent: | Wax 2 | 3 parts |

Production Example 1

Resin: Styrene-butyl acrylate copolymer (weight-average molecular weight: about 300,000; Tg: 60° C.) 100 parts

Colorant: Carbon black (BET specific surface area: 60 m²/g; oil absorption: 115 ml/100 g) 7.5 parts

Charge control agent: Salicylic acid metal compound 2 parts

Release agent: Wax 2 3 parts

The above materials were previously mixed, and the mixture obtained was melt-kneaded at 130° C. by means of a twin-screw extruder. The resulting melt-kneaded product was crushed using a hammer mill to obtain a 1 mm mesh-pass crushed product. This crushed product was further pulverized using an impact mill utilizing a jet stream, followed by air classification to obtain toner particles with a weight-average particle diameter of 7.2 μm. To 100 parts by weight of the toner particles thus obtained, 2.0 parts by weight of hydrophobic silica having a specific surface area of 140 m²/g as measured by the BET method was externally added to obtain Pulverization Toner 1.

Physical properties of the toner thus obtained are shown in Table 2.

The wax in Pulverization Toner 1 was, as shown in FIG. 2B, in a finely dispersed state.

Pulverization Toner

Production Example 2

Pulverization Toner 2 was produced in the same manner as in Pulverization Toner Production Example 1 except that Wax 2 was replaced with Wax 5.

Physical properties of the toner thus obtained are shown in Table 2.

Comparative Pulverization Toner

Production Example 1

Comparative Pulverization Toner 1 was produced in the same manner as in Pulverization Toner Production Example 1 except that Wax 2 was replaced with Comparative Wax 2.

Physical properties of the toner thus obtained are shown in Table 2.

Comparative Pulverization Toner

Production Examples 2 to 4

Comparative Pulverization Toners 2 to 4 were produced in the same manner as in Pulverization Toner Production Example 1 except that Wax 2 was replaced with Comparative Waxes 7 to 9, respectively.

Physical properties of the toners thus obtained are shown in Table 2.

Photosensitive Drum

Production Example 1

An aluminum cylinder of 30 mm diameter and 254 mm long was used as a substrate, on which layers each having such constitution as shown below were successively formed by dip coating. Thus, Photosensitive Drum 1 was produced as a photosensitive member.

(1) Conductive coating layer: Mainly composed of powders of tin oxide and titanium oxide dispersed in phenol resin. Layer thickness: 15 μm.

(2) Subbing layer: Mainly composed of a modified nylon and a copolymer nylon. Layer thickness: 0.6 μm.

(3) Charge generation layer: Mainly composed of an azo pigment having absorption in long wavelength range, dispersed in butyral resin. Layer thickness: 0.6 μm.

(4) Charge transport layer: Mainly composed of a hole-transporting triphenylamine compound dissolved in a polycarbonate resin (molecular weight: 20,000 as measured by Ostwald viscometry) in a weight ratio of 8:10, and in which polytetrafluoroethylene powder (average particle diameter: 0.2 μm) was further added in an amount of 10% by weight based on the total solid content and uniformly dispersed. Layer thickness: 25 μm.

The contact angle to water of the surface of Photosensitive Drum 1 thus obtained was 95 degrees.

To measure the contact angle, pure water was used and as a device used was a contact angle meter Model CA-DS, manufactured by Kyowa Kaimen Kagaku K. K.

Photosensitive Drum

Production Example 2

Photosensitive Drum 2 was produced in the same manner as in Photosensitive Drum Production Example 1 except that the charge transport layer with a layer thickness of 25 μm was formed without addition of the polytetrafluoroethylene powder (average particle diameter: 0.2 μm).

The contact angle to water of the surface of Photosensitive Drum 2 thus obtained was 79 degrees.

### Example 1

As an image forming apparatus used in the present Example, having the constitution as shown in FIG. 5, a commercially available laser printer LBP-8 Mark IV (manufactured by CANON INC.) was modified and re-assembled in the following way:

The surface of the photosensitive member (electrostatic latent image bearing member) 36 was set movable in the direction of an arrow at a rotational peripheral speed of 24 mm/sec [corresponding to a printing speed of 4 sheets (LTR size)/minute]. Here, DC and AC components were applied to the charging roller and the surface of the electrostatic latent image bearing member was uniformly charged. Subsequently, the electrostatic latent image bearing member was exposed to laser light 40 (600 dpi) to form electrostatic latent images, which were developed by the use of the toner 30 to form a toner image as a visible image, and then the toner images were transferred to the transfer medium 38 by means of the transfer roller 37 to which a voltage was applied from the voltage applying means 42.

The developing assembly of the process cartridge was also modified in the following way:

In place of the toner feeding member aluminum sleeve internally provided with a magnet, a medium-resistance rubber roller (diameter: 16 mm) formed of silicone rubber whose resistance had been controlled by dispersing carbon black was used as the toner carrying member 34 and was brought into contact with the electrostatic latent image bearing member 36. The toner carrying member 34 was so driven that the movement of its surface was in the same direction as that of the surface of the electrostatic latent image bearing member 36 at the former's part coming into contact with the latter and its rotational peripheral speed was 200% with respect to the rotational peripheral speed of the electrostatic latent image bearing member; i.e., the toner carrying member was rotated at a peripheral speed of 48 mm/sec, and at a relative peripheral speed of 24 mm/sec with respect to the surface of the electrostatic latent image bearing member 36.

As a means for coating the toner on the toner carrying member, the toner coating roller 35 was provided inside the developer container and was brought into contact with the toner carrying member. The toner coating roller 35 was so rotated that the movement direction of its surface was opposite to the movement direction of the surface of the toner carrying member at the contact part, and in this way the toner was applied on the toner carrying member. Also, for the purpose of controlling the toner coat layer on the toner carrying member, a resin-coated blade 33 made of stainless steel was attached. As the cleaning member of the electrostatic latent image bearing member, a blade 39 made of urethane rubber was used.

Photosensitive Drum 1, which was produced in Photosensitive Drum Production Example 1, was used as the electrostatic latent image bearing member and Polymerization Toner 1 was used as the toner. Process conditions were so set as to fulfill the following development conditions.

Photosensitive member dark-portion potential: −700 V

Photosensitive member light-portion potential: −150 V

Development bias: −450 V (DC component only)

Under the above image forming conditions, toner images transferred to transfer mediums were fixed by means of a fixing assembly of a heat roll system having no function of oil application. The fixing assembly was set at a fixing temperature of 130° C.

A 1,000 sheet printing test was made while supplying the toner to evaluate images. Good results were obtained on all of image density, fog prevention and dot reproducibility. Also, none of fogged images, black spots around line images and faulty cleaning occurred, and the image quality at the initial stage was maintained. After the test, the surfaces of the photosensitive drum and toner carrying member were examined, but no melt-adhesion of toner was seen, and it was unnecessary to change them for new ones.

The results of evaluation are shown in Table 3.

### Example 2

The procedure of Example 1 was repeated except the following conditions.

The toner carrying member 34 was so driven that the movement of its surface was in the same direction as that of the surface of the electrostatic latent image bearing member 36 at the former's part coming into contact with the latter and its rotational peripheral speed was 250% with respect to the rotational peripheral speed of the electrostatic latent image bearing member 36; i.e., the toner carrying member was rotated at a peripheral speed of 60 mm/sec, and at a relative peripheral speed of 36 mm/sec with respect to the surface of the electrostatic latent image bearing member 36.

Polymerization Toner 2 was used as the toner. Process conditions were so set as to fulfill the following development conditions.

Development bias: −350 V (DC component only)

A 1,000 sheet printing test was made while supplying the toner to evaluate images. Good results were obtained on both of image density and dot reproducibility. Also, none of fogged images, black spots around line images and faulty cleaning occurred, and the image quality at the initial stage was maintained. After the test, the surfaces of the photosensitive drum and toner carrying member were examined, but no melt-adhesion of toner was seen, and it was unnecessary to change them for new ones.

The results of evaluation are shown in Table 3.

### Example 3

The procedure of Example 1 was repeated except the following conditions.

The toner carrying member 34 was so driven that the movement of its surface was in the same direction as that of the surface of the electrostatic latent image bearing member 36 at the former's part coming into contact with the latter and its rotational peripheral speed was 150% with respect to the rotational peripheral speed of the electrostatic latent image bearing member 36.

Photosensitive Drum 2, which was produced in Photosensitive Drum Production Example 2, was used as the electrostatic latent image bearing member and Polymerization Toner 3 was used as the toner. Process conditions were so set as to fulfill the following development conditions.

Development bias: −450 V (DC component only)

A 1,000 sheet printing test was made while supplying the toner to evaluate images. Good results were obtained on both of image density and dot reproducibility. Also, none of fogged images, black spots around line images and faulty cleaning occurred, and the image quality at the initial stage was maintained. After the test, the surfaces of the photosensitive drum and toner carrying member were examined. As a result, the melt-adhesion of toner was slightly seen on the toner carrying member, but no influence was seen on images, and the images were those having no problem in practical use.

The results of evaluation are shown in Table 3.

### Examples 4 to 6

The procedure of Example 1 was repeated except for using Polymerization Toners 4 to 6, respectively. Although the reproducibility of latent images of dots of about 50 μm was slightly inferior when polymerization Toner 5 was used, the same good images as in Example 1 were formed throughout the running test.

The results of evaluation are shown in Table 3.

### Examples 7 and 8

The procedure of Example 1 was repeated except for using Pulverization Toners 1 and 2, respectively. Although the image density slightly decreased because of contamination of the toner carrying member, there was no problem in practical use.

The results of evaluation are shown in Table 3.

### Comparative Example 1

The procedure of Example 1 was repeated except that Polymerization Toner 1 was replaced with Comparative Polymerization Toner 1 and process conditions were so again set as to fulfill the following development conditions.

Development bias: −450 V (DC component only)

The printing test was started, whereupon faulty cleaning occurred on the 100th-sheet print. Thereafter, the printing test was continued while cleaning the cleaning blade at every time the faulty cleaning occurred. As a result, on the 400th-sheet print, white spotty faulty images caused by the melt-adhesion of toner to the photosensitive drum surface occurred partly on solid black images. Accordingly, the photosensitive drum was changed for new one. As a result, the faulty images came not to appear, but the image density was not restored to the level of the initial stage.

After the 1,000 sheet printing test was finished, a virgin toner-carrying member was set in the apparatus, and the image density was examined and was found to have been restored to the initial-stage level. The image density was checked using in combination the toner carrying member used up for 1,000 sheets and a new toner, to find that it was 1.30 and was not restored to the initial-stage level.

The results of evaluation are shown in Table 3.

### Comparative Examples 2 to 10

Printing tests were made in the same manner as in Comparative Example 1 except that Comparative Polymerization Toner 1 was replaced with Comparative Polymerization Toners 2 to 10, respectively.

The results of evaluation are shown in Table 3.

### Comparative Example 11

A printing test was made in the same manner as in Example 1 except that the toner was replaced with Comparative Polymerization Toner 2 and the photosensitive drum was replaced with Photosensitive Drum 2, which was produced in Photosensitive Drum Production Example 2. Process conditions were so again set as to fulfill the following development conditions.

Development bias: −350 V (DC component only)

The printing test was started, whereupon faulty cleaning occurred on the 200th-sheet print. Thereafter, the printing test was continued while cleaning the cleaning blade at every time the faulty cleaning occurred. As a result, on the 700th-sheet print, white spotty faulty images caused by the melt-adhesion of toner to the photosensitive drum surface occurred partly on solid black images. Accordingly, the photosensitive drum was changed for new one. As a result, the faulty images came not to appear, but the image density was not restored to the level of the initial stage.

After the 1,000 sheet printing test was finished, virgin photosensitive drum and toner carrying member were set in the apparatus, and the image density was examined and was found to have been restored to the initial-stage level. Meanwhile, the image density was checked using in combination the toner carrying member used up for 1,000 sheets and a new toner, to find that it was 1.28 and was not restored to the initial-stage level. Also, isolated dots were not well reproduced and black spots around line images were conspicuous.

The results of evaluation are shown in Table 3.

### Comparative Example 12

A printing test was made in the same manner as in Example 1 except that the photosensitive drum was replaced with Photosensitive Drum 2, which was produced in Photosensitive Drum Production Example 2, and the toner was replaced with Comparative Pulverization Toner 1.

The image density was as low as 1.0 from the beginning, and faulty cleaning occurred on the 100th-sheet print. The printing test was continued while cleaning the cleaning blade at every time the faulty cleaning occurred. As a result, on the 200th-sheet print, white spotty faulty images caused by the melt-adhesion of toner to the photosensitive drum surface occurred partly on solid black images. Accordingly, the photosensitive drum was changed for new one. As a result, the faulty images came not to appear, but the image density was not restored to the level of the initial stage.

After the 1,000 sheet printing test was finished, virgin photosensitive drum and toner carrying member were set in the apparatus, and the image density was examined and was found to have been restored to the initial-stage level. Meanwhile, the image density was checked using in combination the toner carrying member used up for 1,000 sheets and a new toner, to find that it was 1.28 and was not restored to the initial-stage level.

The results of evaluation are shown in Table 3.

### Comparative Examples 13 to 15

Printing tests were made in the same manner as in Example 1 except that the toner was replaced with Comparative Pulverization Toners 2 to 4, respectively.

The results of evaluation are shown in Table 3.

Polymerization Toner

Production Example 7

Into 710 g of ion-exchanged water held in a 2-liter four-necked flask, 450 g of an aqueous 0.1M-Na₃PO₄ solution was introduced, and the mixture was heated to 60° C., followed by stirring at 12,000 r.p.m. using a high-speed stirrer TK-type homomixer (manufactured by Tokushu Kika Kogyo Co., Ltd.). Then, 68 g of an aqueous 1.0M-CaCl₂ solution was added thereto little by little to obtain an aqueous medium containing a fine-particle, sparingly water-soluble dispersion stabilizer.

Meanwhile, as a disperse phase (dispersoid), the following was prepared.

| | | (by weight) |
|---|---|---|
| Monomers: | Styrene | 165 parts |
| | 2-Butyl acrylate | 35 parts |
| Colorant: | Carbon black (BET specific | 15 parts |
| | surface area: 60 m²/g; oil | |
| | absorption: 85 ml/100 g) | |
| Charge control agent: | Salicylic acid metal compound | 3 parts |
| Polar resin: | Saturated polyester (acid value: | 10 parts |
| | 14 mg KOH/g; peak molecular | |
| | weight: 7,000) | |
| Release agent: | Wax 1 | 50 parts |

A mixture of the above materials was heated to 60° C. and uniformly dissolved, and was dispersed for 3 hours by means of an attritor (manufactured by Mitsui Mining and Smelting Co., Ltd.). In the mixture obtained, 10 parts by weight of a polymerization initiator 2,2′-azobis(2,4-dimethylvaleronitrile) was dissolved. Thus, a polymerizable monomer composition was prepared.

The polymerizable monomer composition obtained was introduced into the above aqueous medium, followed by stirring at 12,000 r.p.m. for 10 minutes at 60° C. in an atmosphere of nitrogen by means of the TK-type homomixer, to carry out granulation of the polymerizable monomer composition. Thereafter, the reaction was carried out at the same temperature for 5 hours while stirring the composition with paddle stirring blades (50 r.p.m.), and thereafter the temperature was raised to 80° C., where the reaction was further carried out for 5 hours. After the polymerization reaction was completed, the residual monomers were evaporated under reduced pressure, the reaction product was cooled, and thereafter hydrochloric acid was added to dissolve away calcium phosphate, followed by filtration, washing with water and drying to obtain black suspension particles having a weight average particle diameter of about 6.9 μm in a sharp particle size distribution.

To 100 parts by weight of the particles thus obtained, 1.5 parts by weight of hydrophobic silica having a specific surface area of 140 m²/g as measured by the BET method was externally added to obtain Polymerization Toner 7.

Physical properties of the toner thus obtained are shown in Table 4.

Polymerization Toner

Production Examples 8 and 9

Polymerization Toners 8 and 9 were produced in the same manner as in Polymerization Toner Production Example 7 except that Wax 1 was replaced with Waxes 2 and 3, respectively.

Physical properties of the toners thus obtained are shown in Table 4.

Polymerization Toner

Production Example 10

Polymerization Toner 10 was produced in the same manner as in Polymerization Toner Production Example 7 except that Wax 1 was replaced with Wax 4 and as the charge control agent the salicylic acid metal compound was replaced with an azo pigment metal compound.

Physical properties of the toner thus obtained are shown in Table 4.

Polymerization Toner

Production Examples 11 and 12

Polymerization Toners 11 and 12 were produced in the same manner as in Polymerization Toner Production Example 10 except that the quantities of the 0.1M-Na₃PO₄ solution and aqueous 1.0M-CaCl₂ solution were controlled so as to produce toners with different particle sizes.

Physical properties of the toners thus obtained are shown in Table 4.

Comparative Polymerization Toner

Production Examples 11 to 20

Comparative Polymerization Toners 11 to 20 were produced in the same manner as in Polymerization Toner Production Example 10 except that Wax 4 was replaced with Comparative Waxes 1 to 10, respectively.

Physical properties of the toners thus obtained are shown in Table 4.

Pulverization Toner

Production Example 3

(by weight)

Resin: Styrene-butyl acrylate copolymer (weight-average molecular weight: about 300,000; Tg: 60° C.) 100 parts

Colorant: Carbon black (BET specific surface area: 60 m²/g; oil absorption: 115 ml/100 g) 7.5 parts

Charge control agent: Salicylic acid metal compound 2 parts

Release agent: Wax 2 3 parts

The above materials were previously mixed, and the mixture obtained was melt-kneaded at 130° C. by means of a twin-screw extruder. The resulting melt-kneaded product was crushed using a hammer mill to obtain a 1 mm mesh-pass crushed product. This crushed product was further pulverized using an impact mill utilizing a jet stream, followed by air classification to obtain toner particles with a weight-average particle diameter of 6.7 μm. To 100 parts by weight of the toner particles thus obtained, 1.5 parts by weight of hydrophobic silica having a specific surface area of 140 m²/g as measured by the BET method was externally added to obtain Pulverization Toner 3.

Physical properties of the toner thus obtained are shown in Table 4.

The wax in Pulverization Toner 3 was, as shown in FIG. 2B, in a finely dispersed state.

Pulverization Toner

Production Example 4

Pulverization Toner 4 was produced in the same manner as in Pulverization Toner Production Example 3 except that Wax 2 was replaced with Wax 6.

Physical properties of the toner thus obtained are shown in Table 4.

Comparative Pulverization Toner

Production Example 5

Comparative Pulverization Toner 5 was produced in the same manner as in Pulverization Toner Production Example 3 except that Wax 2 was replaced with Comparative Wax 2.

Physical properties of the toner thus obtained are shown in Table 4.

Comparative Pulverization Toner

Production Examples 6 to 8

Comparative Pulverization Toners 6 to 8 were produced in the same manner as in Pulverization Toner Production Example 3 except that Wax 2 was replaced with Comparative Waxes 7 to 9, respectively.

Physical properties of the toners thus obtained are shown in Table 4.

### Example 9

As the image forming apparatus as shown in FIG. 4, having a process cartridge not provided with the cleaning member such as a cleaning blade, a commercially available laser printer LBP-860 (manufactured by CANON INC.) was modified and re-assembled in the following way:

The surface of the electrostatic latent image bearing member 36 was set movable in the direction of an arrow at a rotational peripheral speed of 47 mm/sec. The charging system of the apparatus was changed for the contact charging system employing a rubber roller, and a voltage of a DC component (−1,400 V) was applied. The electrostatic latent image bearing member surface electrostatically charged by contact charging was exposed to laser light to form an electrostatic latent image.

Next, the developing part of the process cartridge was modified. A medium-resistance rubber roller (diameter: 16 mm; hardness: ASKER C 45 degrees; resistance: 10⁵ Ω•cm) was used as the toner carrying member, and was brought into contact with the electrostatic latent image bearing member. The toner carrying member was so driven that the movement of its surface was in the same direction as that of the surface of the electrostatic latent image bearing member 36 at the former's part coming into contact with the latter and its rotational peripheral speed was 130% with respect to the rotational peripheral speed of the electrostatic latent image bearing member.

As a means for applying the toner on the toner carrying member, a toner coating roller was provided inside the developer container and was brought into contact with the toner carrying member. Also, for the purpose of coat layer control of the toner on the toner carrying member, a resin-coated blade made of stainless steel was attached.

Photosensitive Drum 1, which was produced in Photosensitive Drum Production Example 1, was used as the electrostatic latent image bearing member and Polymerization Toner 7 was used as the toner. Process conditions were so set as to fulfill the following development conditions. Paper of 75 g/m² in basis weight was used as transfer mediums.

Photosensitive member dark-portion potential: −800 V

Photosensitive member light-portion potential: −150 V

Development bias: −450 V (DC component only)

Under the above developing conditions, electrostatic latent images on the electrostatic latent image bearing member were developed by the use of Polymerization Toner 7, and the toner images formed were transferred to the transfer mediums. The toner images transferred to the transfer mediums were fixed by means of a fixing assembly of a heat roll system having no function of oil application. The fixing assembly was set at a fixing temperature of 130° C.

A 1,000 sheet printing test was made while supplying the toner to evaluate images. Good results were obtained on image density and dot reproducibility. Also, none of faulty images such as stained images, fogged images, black spots around line images and blank areas caused by poor transfer occurred, and images with a high image quality were formed. After the test, the surfaces of the photosensitive drum and toner carrying member were examined, but neither melt-adhesion of toner nor scratch was seen and the toner having adhered to the charging roller was only in a very small quantity, thus it was unnecessary to change them for new ones. There was no problem also on the fixing performance.

The results of evaluation are shown in Table 5.

### Examples 10 to 12

The procedure of Example 9 was repeated to make evaluation, except that the toner was replaced with Polymerization Toners 8 to 10, respectively. The results were as shown in Table 5, and good results were obtained.

### Examples 13 and 14

The procedure of Example 9 was repeated to make evaluation, except that the photosensitive drum was replaced with Photosensitive Drum 2, which was produced in Photosensitive Drum Production Example 2, and the toner was replaced with Polymerization Toner 11. Although a slightly inferior transfer performance was seen which was considered due to a difference in the releasability of the photosensitive member surface, good results were obtained.

The results of evaluation are shown in Table 5.

### Examples 15 and 16

The procedure of Example 9 was repeated to make evaluation, except that the toner was replaced with Pulverization Toners 3 and 4, respectively. Although the charging roller was contaminated with the toner in a slightly large quantity, good results were obtained.

The results of evaluation are shown in Table 5.

### Comparative Examples 16 to 25

The procedure of Example 9 was repeated to make evaluation, except that the toner was replaced with Comparative Polymerization Toners 11 to 20, respectively.

The results of evaluation are shown in Table 5.

### Comparative Examples 26 to 29

The procedure of Example 9 was repeated to make evaluation, except that the toner was replaced with Comparative Pulverization Toners 5 to 8, respectively.

The results of evaluation are shown in Table 5.

Polymerization Toner

### Production Examples 13 to 15

Polymerization Toners 13 to 15 were produced in the same manner as in Polymerization Toner Production Example 1 except that the carbon black was replaced with different colorants.

Physical properties of the toners thus obtained are shown in Table 6.

Comparative Pulverization Toner

### Production Examples 9 to 11

Comparative Pulverization Toners 9 to 11 were produced in the same manner as in Pulverization Toner Production Example 1 except that the carbon black was replaced with different colorants.

Physical properties of the toners thus obtained are shown in Table 6.

### Example 17

Images were formed using the image forming apparatus shown in FIG. 8, having a transfer drum as the intermediate transfer member and a feed roller provided with a bias applying means.

In the image forming apparatus, a cleaner having a cleaning member coming into contact with the electrostatic latent image bearing member surface as a first cleaning means for removing the toner remaining on the electrostatic latent image bearing member surface after primary transfer is provided between the secondary transfer zone and the charging zone where the electrostatic latent image bearing member is charged, and a cleaner having a cleaning member coming into contact with the intermediate transfer member surface as a second cleaning means for removing the toner remaining on the intermediate transfer member surface after secondary transfer is provided on the downstream side of the secondary-transfer zone and the upstream side of the primary-transfer zone.

As the developing assembly 57, a developing assembly constituted like the developing assembly 8 shown in FIG. 6 and 7 was used. It was so constituted that the toner remaining on the photosensitive drum surface was adjusted to negative charge polarity by applying a charging bias at the charging zone and thereafter only the toner present on non-image areas was collected at the developing zone into the developing assembly.

In the developing assembly 8, a medium-resistance rubber roller (diameter: 16 mm) formed of silicone rubber whose resistance had been controlled by dispersing carbon black in it was used as the toner carrying member 9 and was brought into contact with the photosensitive drum surface. The toner carrying member 9 was so driven that the movement of its surface was in the same direction as that of the surface of the photosensitive drum surface at the former's part coming into contact with the latter and its rotational peripheral speed was 150% with respect to the rotational peripheral speed of the photosensitive drum. Namely, the toner carrying member was rotated at a peripheral speed of 120 mm/sec, and at a relative peripheral speed of 40 mm/sec with respect to the surface of the photosensitive drum.

As a means for coating the toner on the toner carrying member, a sponge roller constituted of a single layer was provided as the toner coating roller 12 and was brought into contact with the toner carrying member. The toner coating roller 12 was so rotated that the movement direction of its surface was opposite to the movement direction of the surface of the toner carrying member at the contact part, and in this way the toner was coated on the toner carrying member. Also, for the purpose of coat layer control of the toner on the toner carrying member, a resin-coated blade 16 made of stainless steel was attached.

Photosensitive Drum 1, which was produced in Photosensitive Drum Production Example 1, was used as the photosensitive drum and Polymerization Toner 1 was used as the toner. Image forming conditions were so set as to fulfill the following development conditions.

Photosensitive member dark-portion potential: −700 V

Photosensitive member light-portion potential: −150 V

Development bias applied to the toner carrying member: −450 V (DC component only)

Coating bias applied to the toner coating roller: −450 V (DC component only)

Transfer bias applied to the intermediate transfer member in the primary transfer step: 300 V (DC component only)

Transfer bias applied to the transfer roller in the secondary transfer step: 1,000 V (DC component only)

Under the above image forming conditions, toner images transferred to transfer mediums were fixed to the transfer mediums by means of the following heat fixing assembly.

As the heat fixing assembly 70, a fixing assembly of a heat roll system having no function of oil application was used. Here, the fixing assembly used had fluorine resin surface layers on both the upper roller 68 and the lower roller 69, and the rollers had each a diameter of 60 mm. The fixing temperature was set at 150° C., and the nip width in 7 mm.

Using the image forming apparatus constituted as described above, a 1,000 sheet printing test was made in an environment of normal temperature and normal humidity. As a result, substantially good results were obtained on image density, dot reproducibility and transfer performance, and also fogged images, black spots around line images, stained images and faulty cleaning almost not occurred. After the test, the surfaces of the photosensitive drum and toner carrying member were examined, but no melt-adhesion of toner was seen on the both.

The results of evaluation are shown in Table 7.

### Example 18

From the image forming apparatus used in Example 17, the cleaner having the first cleaning member as the first cleaning means was detached. Then, the transfer residual toner remaining on the photosensitive drum surface after the primary transfer step was adjusted to negative charge polarity by applying a charging bias at the charging zone and thereafter only the toner present on non-image areas was collected at the developing zone into the developing assembly. Also, the development bias applied to the toner carrying member was set to −400 V.

Image formation was tested in the same manner as in Example 17 except that it was made under conditions changed as shown above. As a result, substantially good results were obtained on image density, dot reproducibility and transfer performance, and also fogged images, black spots around line images, stained images and faulty cleaning almost not occurred. After the test, the surfaces of the photosensitive drum and toner carrying member were examined, but no melt-adhesion of toner was seen on the both.

The results of evaluation are shown in Table 7.

### Examples 19 to 21

Printing tests were made in the same manner as in Example 17 except that the toner was replaced with Polymerization Toners 13 to 15, respectively. The results were as shown in Table 7, and good results were obtained.

### Comparative Examples 30 to 33

Printing tests were made in the same manner as in Example 17 except that the toner was replaced with Comparative Pulverization Toner 1 and Comparative Pulverization Toners 9 to 11, respectively.

The results of evaluation are shown in Table 7.

Evaluation items and evaluation criteria of the evaluation made in Examples and Comparative Examples of the present invention are as described below.

Printed-Image Evaluation

(1) Image Density

Image density upon completion of the printing on the stated number of sheets of usual copying plain paper (75 g/m²) was evaluated. The image density was measured with a Macbeth reflection densitometer MACBETH RD918 (manufactured by Macbeth Co.) as a relative density with respect to a printed image on a white background area having an original density of 0.00.

(2) Fixing Performance

Fixing performance was evaluated as a rate (%) of decrease in image density before and after fixed images were rubbed with a soft thin paper under application of a load of 50 g/cm².

A: Very good (less than 5%).

B: Good (from 5% to less than 10%).

C: Average (from 10% to less than 20%).

D: Poor (more than 20%).

(3) Anti-offset Properties

Anti-offset properties were evaluated according to the degree of contamination occurred on images when the preset temperature of the fixing assembly was changed to 180° C. and a sample image with an image area percentage of about 5% was printed.

A: No offset occur.

B: Almost no offset occur.

C: Offset is seen to have slightly occurred, when observed with a magnifier.

D: Offset is seen to have occurred, when visually observed.

(4) Black Spots Around Line Images

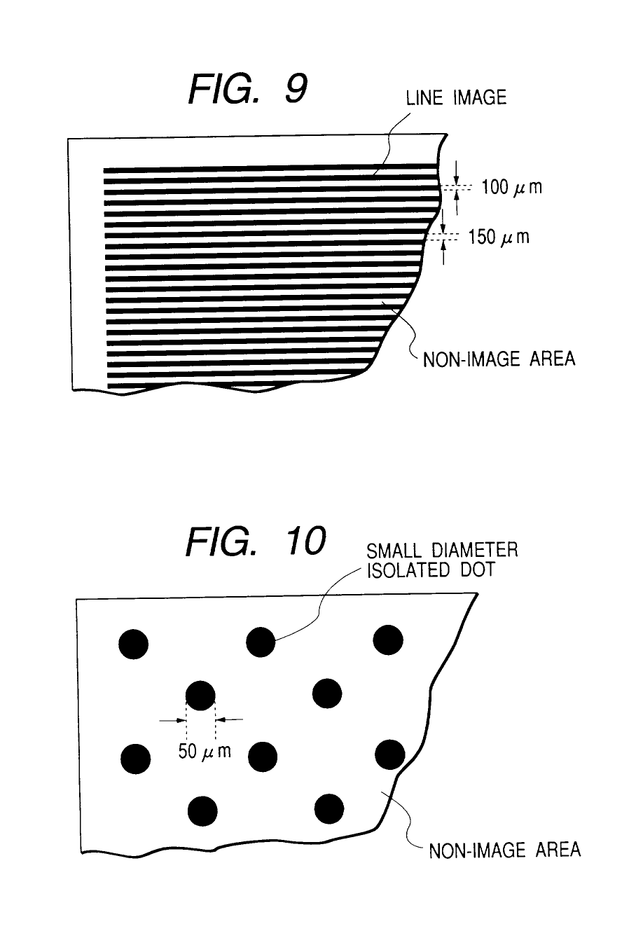

Line pattern images alternately having fine-line image areas of 100 μm wide each and non-image areas of 150 μm wide each as shown in FIG. 9 were printed, and how black spots around line images occurred at the non-image areas between the line image areas were visually examined to make evaluation.

A: Almost no black spots around line images occur.

B: Very slight black spots around line images are seen.

C: Black spots around line images are slightly seen.

D: Conspicuous black spots around line images are seen.

(5) Dot Reproducibility

Images of a pattern of isolated dots of 50 μm diameter each and a pattern of isolated dots of 100 μm diameter each as shown in FIG. 10, which tend to form closed electric fields on account of latent image electric fields and are difficult to reproduce, were printed and the reproducibility of the dots was evaluated.

A: Very good (Missing dots: 2 or less per 100 dots).

B: Good (Missing dots: 3 to 5 per 100 dots).

C: Average (Missing dots: 6 to 10 per 100 dots).

D: Poor (Missing dots: 11 or more per 100 dots).

(6) Fogged Image

In the printing of solid white images, the toner held on the photosensitive drum after the developing step and before the transfer step was stripped off with a transparent pressure-sensitive adhesive tape, which was then evenly stuck on white paper, and its reflection density was measured with the Macbeth reflection densitometer (the same as the above). The quantity of toner on the photosensitive drum was examined to make evaluation on the basis of the difference in reflection density from the reflection density of white paper on which only a tape was stuck. Here, the smaller the value is, the less the toner on the photosensitive drum is and the less the fogged images occur.

(7) Transfer Performance

In the printing of solid black images, the toner remaining on the photosensitive drum after the transfer step and before the cleaning step was stripped off with a transparent pressure-sensitive adhesive tape, which was then evenly stuck on white paper, and the quantity of toner on the photosensitive drum was examined to make evaluation in the same manner as the above evaluation on the fogged image. Here, the smaller the value is, the less the toner on the photosensitive drum is and the better the transfer performance is.

(8) Stained Image

Stained images caused by faulty charging which appeared on images at intervals corresponding to the peripheral length of the charging roller were visually examined to make evaluation.

A: Almost no stained image occurs.

B: Very slightly stained images are seen.

C: Slightly stained images are seen.

D: Conspicuously stained images are seen.

Matching with Image Forming Apparatus

(1) Matching with Toner Carrying Member

After the printing test was finished, whether or not the transfer residual toner adhered to the toner carrying member surface and affected the printed images was visually examined to make evaluation.

A: No adhesion.

B: Almost no adhesion.

C: Adhesion occurs but does not so affects images.

D: Adhesion so greatly occurs as to cause uneven images.

(2) Matching with Photosensitive Drum

After the printing test was finished, any scratches on the photosensitive drum surface and whether or not the transfer residual toner adhered to the surface and affected the printed images were visually examined to make evaluation.

A: No scratches and adhesion.

B: Scratches are slightly seen, but do not affect images.

C: Adhesion and scratches are seen, but do not so affect images.

D: Adhesion so greatly occurs as to cause faulty images in the form of vertical lines.

(3) Matching with Intermediate Transfer Member

After the printing test was finished, any scratches on the intermediate transfer member surface and whether or not the transfer residual toner adhered to the surface and affected the printed images were visually examined to make evaluation.

A: No scratches and adhesion.

B: The transfer residual toner is seen on the surface but no scratches are seen, and does not affect images.

C: Adhesion and scratches are seen, but do not so affect images.

D: Adhesion so greatly occurs as to cause faulty images.

(4) Matching with Charging Roller

Character images having an image area percentage of 4% were continuously printed on 100 sheets. Thereafter, the quantity of the toner adhering to the charging roller was measured and was indicated as a toner build-up (mg/cm²) to make evaluation.

TABLE 1

| | DSC curve, | | | | Number | | | |
|---|---|---|---|---|---|---|---|---|
| | maximum | | | | of peaks | | | |
| | endothermic | | | | detected | | | |
| | peak temp. | (S1/S) × | (S2/S) × | | within | | | |
| | (° C.) | 100 | 100 | S2/S1 | 10-17 ppm | Mw | Mn | Mw/Mn |
| Wax 1 | 71 | 4.0 | 8.4 | 2.1 | 4 | 12,700 | 960 | 13.2 |
| Wax 2 | 96 | 10.6 | 15.0 | 1.5 | 3 | 17.400 | 1,130 | 15.4 |
| Wax 3 | 125 | 2.2 | 4.7 | 2.1 | 2 | 22.300 | 1,100 | 20.3 |
| Wax 4 | 52 | 1.0 | 1.5 | 1.5 | 1 | 1.260 | 215 | 5.9 |
| Wax 5 | 74 | 3.9 | 8.1 | 2.1 | 4 | 14,300 | 1,280 | 11.2 |
| Wax 6 | 92 | 4.8 | 8.3 | 1.8 | 3 | 15.600 | 1,020 | 15.3 |
| Wax 7 | 69 | 2.3 | 5.9 | 2.6 | 1 | 1.530 | 230 | 6.6 |
| Wax 8 | 105 | 5.2 | 8.8 | 1.7 | 3 | 19.700 | 1,040 | 18.7 |
| Comp. Wax 1 | 48 | 0.0 | 0.1 | — | 1 | 390 | 310 | 1.3 |
| Comp. Wax 2 | 136 | 14.0 | 6.0 | 0 | 1 | 8,890 | 1,010 | 8.8 |
| Comp. Wax 3 | 110 | 0.5 | 0.1 | 0.2 | 1 | 1,640 | 1,370 | 1.2 |
| Comp. Wax 4 | 134 | 0.6 | 0.1 | 0.17 | 0 | 8,700 | 980 | 8.9 |
| Comp. Wax 5 | 76 | 0.4 | 0.2 | 0.5 | 1 | 620 | 475 | 1.3 |
| Comp. Wax 6 | 51 | 0.0 | 0.1 | — | 2 | 880 | 690 | 1.3 |
| Comp. Wax 7 | 121 | 11.5 | 19.4 | 1.7 | 5 | 6,350 | 870 | 7.3 |
| Comp. Wax 8 | 85 | 0.7 | 1.2 | 1.7 | 1 | 1,100 | 750 | 1.5 |
| Comp. Wax 9 | 139 | 3.6 | 16.0 | 4.4 | 4 | 14,200 | 1,180 | 12 |
| Comp. Wax 10 | 129 | 1.6 | 1.3 | 0.8 | 1 | 2,270 | 840 | 2.7 |

Comp. Wax: Comparative Wax

TABLE 2

| | | | | Weight | |
|---|---|---|---|---|---|
| | | | | average | |
| | | | | particle | |
| | | | | diameter | |
| | | Shape factor | | D4 | State of wax |
| | Wax | SF-1 | SF-2 | (μm) | dispersed |
| Polymerization | | | | | |
| Toner: | | | | | |
| 1 | Wax 1 | 112 | 107 | 6.8 | Spherical |
| 2 | Wax 2 | 115 | 112 | 7.0 | Spherical |
| 3 | Wax 3 | 116 | 110 | 6.6 | Spindle-like |
| | | | | | islands |
| 4 | Wax 4 | 127 | 120 | 7.3 | Spherical |
| 5 | Wax 4 | 135 | 128 | 8.4 | Spherical |
| 6 | Wax 4 | 120 | 115 | 5.8 | Spherical |
| Comparative | | | | | |
| Polymerization | | | | | |
| Toner: | | | | | |
| 1 | Comp. Wax 1 | 131 | 125 | 7.1 | Spherical |
| 2 | Comp. Wax 2 | 142 | 130 | 7.5 | Spindle-like |
| | | | | | islands |
| 3 | Comp. Wax 3 | 144 | 127 | 7.2 | Spindle-like |
| | | | | | islands |
| 4 | Comp. Wax 4 | 136 | 122 | 7.5 | Spindle-like |
| | | | | | islands |
| 5 | Comp. Wax 5 | 132 | 124 | 7.4 | Spherical |
| 6 | Comp. Wax 6 | 141 | 135 | 7.6 | Spherical |
| 7 | Comp. Wax 7 | 134 | 121 | 6.2 | Spherical |
| 8 | Comp. Wax 8 | 142 | 136 | 7.5 | Spherical |
| 9 | Comp. Wax 9 | 132 | 125 | 8.1 | Spindle-like |
| | | | | | islands |
| 10 | Comp. Wax 10 | 133 | 131 | 7.9 | Spindle-like |
| | | | | | islands |
| Pulverization | | | | | |
| Toner: | | | | | |
| 1 | Wax 2 | 158 | 137 | 7.2 | Finely |
| | | | | | dispersed |
| 2 | Wax 5 | 143 | 122 | 6.8 | Finely |
| | | | | | dispersed |
| Comparative | | | | | |
| Pulverization | | | | | |
| Toner: | | | | | |
| 1 | Comp. Wax 2 | 168 | 148 | 9.3 | Finely |
| | | | | | dispersed |
| 2 | Comp. Wax 7 | 162 | 142 | 7.5 | Finely |
| | | | | | dispersed |
| 3 | Comp. Wax 8 | 164 | 145 | 7.4 | Finely |
| | | | | | dispersed |
| 4 | Comp. Wax 9 | 163 | 144 | 7.7 | Finely |
| | | | | | dispersed |

Comp. Wax: Comparative Wax

TABLE 3
*as shown in the specification

| | | Photo- | Printed-image evaluation (1)-(7)* | | | | | | | | | | | |
|---|---|---|---|---|---|---|---|---|---|---|---|---|---|---|
| | | sensi- | (1) Image density | | | | | | (5) | | | | | Melt- |
| | | tive | Ini- | After | New | | | | 50 | 100 | | | Faulty | adhesion |
| | | Drum | tial | 1,000 sh. | toner | (2) | (3) | (4) | μm | μm | (6) | (7) | cleaning | to drum |
| | Polymerization | | | | | | | | | | | | **occurred on | |
| Example: | Toner: | | | | | | | | | | | | | |
| 1 | 1 | 1 | 1.46 | 1.44 | 1.46 | A | A | A | A | A | 0.05 | 0.01 | none | none |
| 2 | 2 | 1 | 1.46 | 1.43 | 1.45 | A | A | A | B | A | 0.04 | 0.02 | none | none |
| 3 | 3 | 2 | 1.48 | 1.44 | 1.45 | B | A | A | A | A | 0.05 | 0.06 | none | none |
| 4 | 4 | 1 | 1.40 | 1.37 | 1.39 | A | B | A | B | A | 0.03 | 0.03 | none | none |
| 5 | 5 | 1 | 1.45 | 1.40 | 1.41 | A | A | B | B | B | 0.06 | 0.04 | none | none |
| 6 | 6 | 1 | 1.47 | 1.45 | 1.45 | A | A | A | A | A | 0.06 | 0.05 | none | none |
| | Pulverization | | | | | | | | | | | | | |
| | Toner: | | | | | | | | | | | | | |
| 7 | 1 | 1 | 1.40 | 1.38 | 1.38 | C | B | A | B | A | 0.04 | 0.10 | none | none |
| 8 | 2 | 1 | 1.37 | 1.33 | 1.34 | B | C | B | B | B | 0.05 | 0.08 | none | none |
| | Comparative | | | | | | | | | | | | | |
| Comparative | Polymerization | | | | | | | | | | | | | |
| Example: | Toner: | | | | | | | | | | | | ** | ** |
| 1 | 1 | 1 | 1.35 | 1.05 | 1.26 | C | C | B | B | B | 0.07 | 0.08 | 100th sh. | 400th sh. |
| 2 | 2 | 1 | 1.36 | 1.21 | 1.25 | D | B | B | C | B | 0.06 | 0.09 | 200th sh. | 700th sh. |
| 3 | 3 | 1 | 1.29 | 0.98 | 1.10 | C | C | B | C | B | 0.14 | 0.10 | 300th sh. | 400th sh. |
| 4 | 4 | 1 | 1.25 | 0.95 | 1.08 | D | B | C | C | B | 0.19 | 0.07 | 400th sh. | 600th sh. |
| 5 | 5 | 1 | 1.10 | 0.80 | 1.00 | B | C | C | C | B | 0.18 | 0.07 | 200th sh. | 300th sh. |
| 6 | 6 | 1 | 1.28 | 0.99 | 1.07 | B | C | B | C | B | 0.33 | 0.08 | 400th sh. | 500th sh. |
| 7 | 7 | 1 | 1.27 | 0.96 | 1.10 | D | B | D | B | B | 0.50 | 0.06 | 800th sh. | none |
| 8 | 8 | 1 | 1.12 | 0.89 | 0.95 | C | C | D | C | C | 0.19 | 0.08 | 700th sh. | 800th sh. |
| 9 | 9 | 1 | 1.27 | 0.95 | 0.99 | D | B | D | D | C | 0.47 | 0.07 | 700th sh. | none |
| 10 | 10 | 1 | 1.27 | 0.70 | 1.06 | D | B | D | D | C | 0.33 | 0.09 | 300th sh. | 400th sh. |
| 11 | 2 | 2 | 1.09 | 0.58 | 0.94 | D | B | D | D | C | 0.31 | 0.15 | 200th sh. | 300th sh. |
| | Comparative | | | | | | | | | | | | | |
| | Pulverization | | | | | | | | | | | | | |
| | Toner: | | | | | | | | | | | | | |
| 12 | 1 | 2 | 1.00 | 0.55 | 0.72 | D | A | D | D | D | 0.15 | 0.51 | 100th sh. | 200th sh. |
| 13 | 2 | 1 | 1.17 | 0.61 | 0.90 | D | B | D | D | C | 0.09 | 0.34 | 400th sh. | 500th sh. |
| 14 | 3 | 1 | 1.19 | 0.48 | 0.85 | C | B | D | D | C | 0.19 | 0.52 | 200th sh. | 300th sh. |
| 15 | 4 | 1 | 1.25 | 0.59 | 1.00 | D | A | D | D | C | 0.15 | 0.47 | 700th sh. | 800th sh. |

TABLE 4

| | | | | Weight | |
|---|---|---|---|---|---|
| | | | | average | |
| | | | | particle | |
| | | | | diameter | |
| | | Shape factor | | D4 | State of wax |
| | Wax | SF-1 | SF-2 | (μm) | dispersed |
| Polymerization | | | | | |
| Toner: | | | | | |
| 7 | Wax 1 | 112 | 107 | 6.9 | Spherical |
| 8 | Wax 2 | 115 | 112 | 7.2 | Spherical |
| 9 | Wax 3 | 116 | 114 | 6.7 | Spindle-like |
| | | | | | islands |
| 10 | Wax 4 | 127 | 120 | 7.5 | Spherical |
| 11 | Wax 4 | 135 | 130 | 8.5 | Spherical |
| 12 | Wax 4 | 120 | 115 | 5.9 | Spherical |
| Comparative | | | | | |
| Polymerization | | | | | |
| Toner: | | | | | |
| 11 | Comp. Wax 1 | 127 | 125 | 7.1 | Spherical |
| 12 | Comp. Wax 2 | 134 | 140 | 9.2 | Spindle-like |
| | | | | | islands |
| 13 | Comp. Wax 3 | 143 | 128 | 7.4 | Spindle-like |
| | | | | | islands |
| 14 | Comp. Wax 4 | 135 | 123 | 7.9 | Spindle-like |
| | | | | | islands |
| 15 | Comp. Wax 5 | 131 | 123 | 7.8 | Spherical |
| 16 | Comp. Wax 6 | 140 | 134 | 7.2 | Spherical |
| 17 | Comp. Wax 7 | 134 | 127 | 6.1 | Spherical |
| 18 | Comp. Wax 8 | 141 | 134 | 7.4 | Spherical |
| 19 | Comp. Wax 9 | 133 | 127 | 7.5 | Spindle-like |
| | | | | | islands |
| 20 | Comp. Wax 10 | 134 | 130 | 8.4 | Spindle-like |
| | | | | | islands |
| Pulverization | | | | | |
| Toner: | | | | | |
| 3 | Wax 2 | 165 | 155 | 7.6 | Finely |
| | | | | | dispersed |
| 4 | Wax 6 | 142 | 126 | 7.0 | Finely |
| | | | | | dispersed |
| Comparative | | | | | |
| Pulverization | | | | | |
| Toner: | | | | | |
| 5 | Comp. Wax 2 | 167 | 154 | 7.7 | Finely |
| | | | | | dispersed |
| 6 | Comp. Wax 7 | 162 | 144 | 6.9 | Finely |
| | | | | | dispersed |
| 7 | Comp. Wax 8 | 163 | 145 | 6.5 | Finely |
| | | | | | dispersed |
| 8 | Comp. Wax 9 | 161 | 142 | 6.8 | Finely |
| | | | | | dispersed |

Comp. Wax: Comparative Wax

TABLE 5
*as shown in the specification

| | | | | | | | | | | | | Matching with: | | |
|---|---|---|---|---|---|---|---|---|---|---|---|---|---|---|
| | | Photo- | Printed-image evaluation (1)-(8)* | | | | | | | | | Toner | Photo- | |
| | | sensi- | (1) | | | | (5) | | | | | carry- | sensi- | Charging |
| | | tive | Image | | | | 50 | 100 | | | | ing | tive | roller |
| | | Drum | density | (2) | (3) | (4) | μm | μm | (6) | (7) | (8) | member | drum | (mg/cm²) |
| | Polymerization | | | | | | | | | | | | | |
| Example: | Toner: | | | | | | | | | | | | | |
| 9 | 7 | 1 | 1.47 | A | A | A | A | A | 0.03 | 0.01 | A | A | A | 0.36 |
| 10 | 8 | 1 | 1.45 | A | A | A | A | A | 0.02 | 0.02 | A | A | A | 0.40 |
| 11 | 9 | 1 | 1.46 | B | A | A | A | A | 0.03 | 0.05 | A | A | B | 0.38 |
| 12 | 10 | 1 | 1.42 | A | B | A | B | A | 0.01 | 0.03 | A | B | B | 0.42 |
| 13 | 11 | 2 | 1.44 | A | A | A | B | B | 0.04 | 0.05 | A | A | B | 0.33 |
| 14 | 12 | 2 | 1.48 | A | A | A | A | A | 0.05 | 0.04 | A | A | B | 0.49 |
| | Pulverization | | | | | | | | | | | | | |
| | Toner: | | | | | | | | | | | | | |
| 15 | 3 | 1 | 1.41 | C | B | B | C | B | 0.03 | 0.11 | A | B | B | 0.71 |
| 16 | 4 | 1 | 1.39 | B | C | B | B | B | 0.04 | 0.10 | A | B | B | 0.66 |
| | Comparative | | | | | | | | | | | | | |
| Comparative | Polymerization | | | | | | | | | | | | | |
| Example: | Toner: | | | | | | | | | | | | | |
| 16 | 11 | 1 | 1.07 | C | C | A | B | A | 0.08 | 0.08 | D | D | D | 0.85 |
| 17 | 12 | 1 | 1.20 | D | B | C | C | B | 0.07 | 0.07 | D | C | D | 0.79 |
| 18 | 13 | 1 | 1.00 | C | C | C | C | C | 0.12 | 0.09 | D | C | C | 0.64 |
| 19 | 14 | 1 | 0.94 | D | B | D | C | D | 0.17 | 0.06 | D | C | C | 0.54 |
| 20 | 15 | 1 | 0.85 | B | C | D | D | D | 0.18 | 0.07 | D | D | D | 0.61 |
| 21 | 16 | 1 | 1.30 | B | C | B | C | B | 0.07 | 0.05 | D | C | D | 0.72 |
| 22 | 17 | 1 | 0.95 | D | B | C | C | C | 0.44 | 0.09 | D | C | C | 0.65 |
| 23 | 18 | 1 | 0.90 | C | C | C | D | C | 0.21 | 0.07 | C | C | D | 0.44 |
| 24 | 19 | 1 | 0.93 | D | B | C | D | C | 0.40 | 0.07 | D | C | D | 0.75 |
| 25 | 20 | 1 | 0.72 | D | B | D | D | D | 0.35 | 0.09 | D | C | C | 0.69 |
| | Comparative | | | | | | | | | | | | | |
| | Pulverization | | | | | | | | | | | | | |
| | Toner: | | | | | | | | | | | | | |
| 26 | 5 | 1 | 0.57 | D | A | C | D | D | 0.07 | 0.39 | D | D | D | 0.80 |
| 27 | 6 | 1 | 0.62 | D | B | C | D | D | 0.06 | 0.32 | D | D | D | 1.05 |
| 28 | 7 | 1 | 0.50 | C | B | C | D | C | 0.09 | 0.50 | D | D | D | 0.74 |
| 29 | 8 | 1 | 0.58 | D | A | D | D | D | 0.08 | 0.48 | D | C | C | 0.72 |

TABLE 6

| | | | | Weight | |
|---|---|---|---|---|---|
| | | | | average | |
| | | | | particle | |
| | | | | diam- | |
| | | Shape factor | | eter D4 | State of wax |
| | Colorant | SF-1 | SF-2 | (μm) | dispersed |
| Polymerization | | | | | |
| Toner: | | | | | |
| 13 | Cyan colorant | 119 | 110 | 6.5 | Spherical |
| | (C.I. Pigment | | | | |
| | Blue 15:3) | | | | |
| 14 | Magenta colorant | 121 | 107 | 6.2 | Spherical |
| | (C.I. Pigment | | | | |
| | Red 202) | | | | |
| 15 | Yellow colorant | 118 | 110 | 6.1 | Spherical |
| | (C.I. Pigment | | | | |
| | yellow 17) | | | | |
| Comparative | | | | | |
| Pulverization | | | | | |
| Toner: | | | | | |
| 9 | Cyan colorant | 165 | 147 | 7.8 | Finely |
| | (C.I. Pigment | | | | dispersed |
| | Blue 15:3) | | | | |
| 10 | Magenta colorant | 160 | 144 | 7.5 | Finely |
| | (C.I. Pigment | | | | dispersed |
| | Red 202) | | | | |
| 11 | Yellow colorant | 161 | 140 | 7.4 | Finely |
| | (C.I. Pigment | | | | dispersed |
| | yellow 17) | | | | |

TABLE 7
*as shown in the specification

| | | | | | | | | Matching with: | | |
|---|---|---|---|---|---|---|---|---|---|---|
| | | Printed-image evaluation (1), (4)-(7)* | | | | | | | | Inter- |
| | | (1) | | (5) | | | | Toner | Photo- | mediate |
| | | Image | | 50 | 100 | | | Carrying | sensitive | transfer |
| | | density | (4) | μm | μm | (6) | (7) | member | drum | member |
| | Polymerization | | | | | | | | | |
| Example: | Toner: | | | | | | | | | |
| 17 | 1 | 1.37 | A | A | A | 0.05 | 0.02 | A | A | A |
| 18 | 1 | 1.37 | A | A | A | 0.06 | 0.02 | A | A | A |
| 19 | 13 | 1.30 | A | B | A | 0.07 | 0.03 | A | A | A |
| 20 | 14 | 1.35 | A | A | A | 0.02 | 0.01 | A | A | A |
| 21 | 15 | 1.34 | A | A | A | 0.05 | 0.04 | A | A | A |
| | Comparative | | | | | | | | | |
| Comparative | Pulverization | | | | | | | | | |
| Example: | Toner: | | | | | | | | | |
| 30 | 1 | 0.94 | D | D | D | 0.18 | 0.31 | D | D | D |
| 31 | 9 | 1.07 | C | D | C | 0.10 | 0.22 | D | D | D |
| 32 | 10 | 1.15 | C | D | C | 0.12 | 0.16 | D | D | D |
| 33 | 11 | 0.91 | C | D | C | 0.09 | 0.17 | D | D | D |

In Tables 1 to 7;
(1): Image density
(2): Fixing performance
(3): Anti-offset properties
(4): Black spots around line images
(5): Dot reproducibility
(6): Fogged image
(7): Transfer performance
(8): Stained image

### Example 22

Formation of full-color images was tested in the same manner as in Example 17 except that the toner was replaced with Polymerization Toners 12 to 15. As a result, good images were formed.

### Comparative Example 34

Formation of full-color images was tested in the same manner as in Example 17 except that the toner was replaced with Comparative Pulverization Toner 1 and Comparative Pulverization Toners 9 to 11. As a result, the toners so poorly matched with the image forming apparatus as to cause faulty images.

### Comparative Example 35

Formation of images was tested in the same manner as in Example 18 except that the toner was replaced with Comparative Pulverization Toner 1. As a result, the toner seriously contaminated the charging roller to cause faulty charging, so that the test had to be stopped in the middle.

### Example 23

Using the image forming apparatus constituted as shown in FIG. 5, images were formed to make a 2,000 sheet printing test in the same manner as in Example 1 except that a bias applying means was attached to the toner coating roller and a bias voltage (−300 V) was applied thereto. After the printing test was finished, the surface of the toner carrying member was examined. As a result, no toner was seen to have adhered to the surface and the toner was found to have been well stripped off. Also, images formed had a high quality.

### Example 24

Using the image forming apparatus constituted as shown in FIG. 6, images were formed to make a 2,000 sheet printing test in the same manner as in Example 9 except that a feed bias of −300 V was applied to the toner coating roller. After the printing test was finished, the surface of the toner carrying member was examined. As a result, no toner was seen to have adhered to the surface and the toner was found to have been well stripped off. Also, images formed had a high quality.

What is claimed is:

1. An image forming method comprising;
a charging step of electrostatically charging an electrostatic latent image bearing member;
an electrostatic latent image forming step of subjecting the electrostatic latent image bearing member thus charged, to exposure to form thereon an electrostatic latent image;
a developing step of developing the electrostatic latent image by the use of a toner carried on the surface of a toner carrying member, to form a toner image; and
a transfer step of transferring the toner image to a transfer medium via, or not via, an intermediate transfer member;
wherein, in said developing step, a toner layer formed by the toner carried on the surface of the toner carrying member is brought into contact with the surface of the electrostatic latent image bearing member; and said toner comprises toner particles containing at least a binder resin, a colorant and a wax;
said wax:
(a) in a DSC curve measured with a differential scanning calorimeter, showing a maximum endothermic peak in a region of from 50° C. to 130° C. at the time of temperature rise; and (b) in a spectrum measured with a ¹³C-NMR nuclear magnetic resonance spectrometer, satisfying the following conditions:
1.0≦[(S1/S)×100]≦10.0
1.5≦[(S2/S)×100]≦15.0
S1<S2
wherein S represents a total area of peaks detected in a region of from 0 ppm to 50 ppm, S1 represents a total area of peaks detected in a region of from 36 ppm to 42 ppm, and S2 represents a total area of peaks detected in a region of from 10 ppm to 17 ppm.

2. The image forming method according to claim 1, wherein said toner has an inorganic finer powder.

3. The image forming method according to claim 2, wherein said inorganic finer powder has an inorganic compound selected from the group consisting of silicon oxide, aluminum oxide, titanium oxide and a double oxide of any of these.

4. The image forming method according to claim 1, wherein said wax has, in the spectrum measured with a ¹³C-NMR nuclear magnetic resonance spectrometer, a plurality of peaks in the region of from 10 ppm to 17 ppm.

5. The image forming method according to claim 1, wherein said wax has a weight-average molecular weight Mw of from 600 to 50,000.

6. The image forming method according to claim 1, wherein said wax has a weight-average molecular weight Mw of from 800 to 40,000.

7. The image forming method according to claim 1, wherein said wax has a weight-average molecular weight Mw of from 1,000 to 30,000.

8. The image forming method according to claim 1, wherein said wax has a number-average molecular weight Mn of from 400 to 40,000.

9. The image forming method according to claim 1, wherein said wax has a number-average molecular weight Mn of from 450 to 35,000.

10. The image forming method according to claim 1, wherein said wax has a ratio of a weight-average molecular weight Mw to a number-average molecular weight Mn, Mw/Mn, of from 3.5 to 30.

11. The image forming method according to claim 1, wherein said wax has a ratio of a weight-average molecular weight Mw to a number-average molecular weight Mn, Mw/Mn, of from 4.0 to 25.

12. The image forming method according to claim 1, wherein said wax has, in the spectrum measured with a ¹³C-NMR nuclear magnetic resonance spectrometer, the total area S of the peaks detected in the region of from 0 ppm to 50 ppm, the total area S1 of the peaks detected in the region of from 36 ppm to 42 ppm and the total area S2 of the peaks detected in the region of from 10 ppm to 17 ppm which satisfy the following conditions:
1.5≦[(S1/S)×100]≦8.0
2.0≦[(S2/S)×100]≦13.0.

13. The image forming method according to claim 1, wherein said wax has, in the spectrum measured with a ¹³C-NMR nuclear magnetic resonance spectrometer, the total area S of the peaks detected in the region of from 0 ppm to 50 ppm, the total area S1 of the peaks detected in the region of from 36 ppm to 42 ppm and the total area S2 of the peaks detected in the region of from 10 ppm to 17 ppm which satisfy the following conditions:
2.0≦[(S1/S)×100]≦6.0
3.0≦[(S2/S)×100]≦10.0.

14. The image forming method according to claim 1, wherein said wax has, in the DSC curve, a maximum endothermic peak in the region of from 60° C. to 120° C. at the time of temperature rise.

15. The image forming method according to claim 1, wherein said wax has, in the DSC curve, a maximum endothermic peak in the region of from 65 to 100° C. at the time of temperature rise.

16. The image forming method according to claim 1, wherein said wax has a branched structure represented by the following general formula. 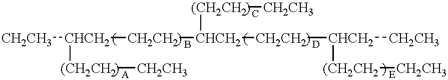
wherein A, C and E each represent an integer of 1 or more, and B and D each represent an integer.

17. The image forming method according to claim 1, wherein said wax is a copolymer of an α-monoolefinic hydrocarbon represented by the formula: 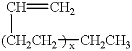
wherein x represents an integer of 1 or more; with ethylene.

18. The image forming method according to claim 17, wherein said α-monoolefinic hydrocarbon has a value of x of from 5 to 30 on an average.

19. The image forming method according to claim 1, wherein in observation of cross sections of the toner particles with a transmission electron microscope, said wax is dispersed in the binder resin in a form of a substantially sphere and/or a spindle-shaped island in such a state that the wax and the binder resin are not dissolved in each other.

20. The image forming method according to claim 1, wherein said toner particles have a weight-average particle diameter of from 3 μm to 9 μm.

21. The image forming method according to claim 1, wherein said toner particles have a weight-average particle diameter of from 4 μm to 8 μm.

22. The image forming method according to claim 1, wherein said toner particles have a value of shape factor SF-1 of 100<SF-1≦160 and a value of shape factor SF-2 of 100<SF-2≦140.

23. The image forming method according to claim 1, wherein said toner particles have the value of shape factor SF-1 of 100<SF-1≦140 and the value of shape factor SF-2 of 100<SF-2 ≦120.

24. The image forming method according to claim 1, wherein said toner particles are toner particles produced by polymerization.

25. The image forming method according to claim 1, wherein said toner particles have a core/shell structure.

26. The image forming method according to claim 25, wherein said toner particles having a core/shell structure comprises a core composed chiefly of the wax; said wax having a melting point of from 40° C. to 90° C.

27. The image forming method according to claim 1, which further comprises, after said transfer step, a cleaning step of cleaning the surface of the electrostatic latent image bearing member to collect the toner remaining on that surface.

28. The image forming method according to claim 27, wherein said cleaning step is a cleaning-before-development system in which, after the transfer step and before the charging step, the surface of the electrostatic latent image bearing member is cleaned by means of a cleaning member coming into contact with the surface of the electrostatic latent image bearing member.

29. The image forming method according to claim 27, wherein said cleaning step is a cleaning-at-development system in which, in the course of the developing step, the toner remaining on the surface of the electrostatic latent image bearing member is collected by the toner carrying member to clean the surface of the electrostatic latent image bearing member.

30. The image forming method according to claim 1, wherein said electrostatic latent image bearing member comprises an electrophotographic photosensitive member, and the surface of the photosensitive member has a contact angle to water of 85 degrees or more.

31. The image forming method according to claim 1, wherein said electrostatic latent image bearing member comprises an electrophotographic photosensitive member, and the surface of the photosensitive member has a contact angle to water of 90 degrees or more.

32. The image forming method according to claim 30, wherein said electrostatic latent image bearing member has a surface layer in which a compound powder containing a fluorine atom has been dispersed in a resin.

33. The image forming method according to claim 1, wherein, in said developing step, the movement of the surface of the toner carrying member in the developing zone is set in the same direction as the direction of movement of the surface of the electrostatic latent image bearing member.

34. The image forming method according to claim 33, wherein, in said developing step, the movement of the surface of the toner carrying member in the developing zone is set at a velocity of from 1.05 times to 3.0 times the velocity of movement of the surface of the electrostatic latent image bearing member.

35. The image forming method according to claim 1, wherein, in said developing step, a toner layer thickness regulation member is brought into contact with the toner carried on the toner carrying member, to form a toner layer the layer thickness of which has been regulated.

36. The image forming method according to claim 1, wherein said toner is held in a developing assembly, and the toner held in the developing assembly is fed onto the toner carrying member by means of a toner feeding member for feeding the toner onto the toner carrying member.

37. The image forming method according to claim 36, wherein said toner feeding member comprises a toner coating roller coming into contact with the surface of the toner carrying member, and the movement of the surface of the toner coating roller is set in the direction opposite to the direction of movement of the surface of the toner carrying member.

38. The image forming method according to claim 37, wherein a development bias voltage is applied to the toner carrying member at the time of development of the electrostatic latent image, and a coating bias voltage is applied to the toner coating roller at the time of feeding the toner to the toner carrying member.

39. The image forming method according to claim 38, wherein the coating bias voltage applied to the toner coating roller is set greater as an absolute value than the development bias voltage applied to the toner carrying member, and the toner coating roller feeds the toner to the surface of the toner carrying member and strips the toner remaining on the surface of the toner carrying member after development.

40. The image forming method according to claim 38, wherein the light-portion potential and dark-portion potential of the electrostatic latent image on the electrostatic latent image bearing member have an absolute value of from 0 V to 250 V and an absolute value of from 100 V to 1000 V, respectively, the coating bias voltage applied to the toner coating roller has an absolute value of from 100 V to 900 V, the development bias voltage applied to the toner carrying member has an absolute value of from 100 V to 900 V, the coating bias voltage is set greater by 10 V to 400 V as an absolute value than the development bias voltage, and the toner coating roller feeds the toner to the surface of the toner carrying member and strips the toner remaining on the surface of the toner carrying member after development.

41. The image forming method according to claim 1, wherein, in said transfer step, a transfer member to which a voltage is applied from the outside is brought into contact with the electrostatic latent image bearing member through the transfer medium to transfer to the transfer medium the toner image formed on the electrostatic latent image bearing member.

42. The image forming method according to claim 1, wherein, in said transfer step, as the transfer medium a recording medium is used, and the toner image transferred to the recording medium is fixed to the recording medium.

43. The image forming method according to claim 1, wherein, in said charging step, a charging member to which a voltage is applied from the outside is brought into contact with the electrostatic latent image bearing member to charge the electrostatic latent image bearing member.

44. The image forming method according to claim 1, wherein, in said charging step, a direct current voltage is applied to the charging member from the outside.

45. The image forming method according to claim 1, wherein, in said charging step, a direct current voltage and an alternating current voltage of less than twice the voltage at which discharge begins under application of the direct current voltage are applied to the charging member from the outside.
